(19) United States
(12) Patent Application Publication
(10) Pub. No.: US 2002/0112237 A1
(43) Pub. Date: Aug. 15, 2002

(54) System and method for providing an interactive display interface for information objects

(76) Inventor: Brett R. Kelts, Newport Beach, CA (US)

Correspondence Address: Terrance A. Meador, Gray Cary Ware & Freidenrich, Suite 1700, 401 B Street, San Diego, CA, 92101-4297, US

(21) Appl. No.: 09/746,368

(22) Filed: Dec. 22, 2000

Related U.S. Application Data
(60) Provisional application No. 60/195,955, filed on Apr. 10, 2000.

(51) Int. Cl. H04N 5/445; G06F 3/00; G06F 13/00; H04N 7/173; H04N 7/16

(52) U.S. Cl. 725/39; 725/51; 725/109; 725/135

(57) ABSTRACT

A navigation interface display system generates a navigation map that organizes a plurality of information sources in an easy-to-use manner. In practical embodiments, the information sources are cable or satellite television stations, online music or video files, or the like. The navigation map employs a hierarchical display protocol for a plurality of map items that serve as links to the various content sources. The hierarchical display scheme displays a limited number of active map items at a first magnification level and additional active map items at a second magnification level. In addition, the map items are displayed on distinctive areas or features of the map, where such features represent different content genres or categories. Subcategories can also be displayed in a hierarchical manner, thus providing additional information related to the content as the magnification level of the map changes. The navigation interface display system is deployed in a layered architecture with centralized servers, centralized databases related to the map data and the content data, and different presentation layers associated with different presentation or display devices (such as television systems, personal computers, wireless telephones, personal digital assistants, etc.). The layered architecture allows a single deployment of the display system to service multiple users, where each user can utilize any number of different presentation devices.

### CROSS REFERENCE TO RELATED APPLICATIONS

This application claims priority of United States provisional patent application Ser. No. 60/195,955, titled “Method and Apparatus for Providing Streaming Media in a Communication Network,” filed Apr. 10, 2000. This application is related to United States patent application Ser. No.________ , titled “Interactive Display Interface for Information Objects,” filed__________.

### FIELD OF THE INVENTION

The present invention relates generally to interactive menu interfaces for identifying content provided via a communication system, a computer system, or other electronic equipment. More particularly, the present invention relates to a system for retrieving programming information and for generating an interactive navigation interface for displaying such programming information.

### BACKGROUND OF THE INVENTION

The prior art is replete with communication and entertainment systems that provide information in different formats to many users. For example, digital cable and satellite television systems, which are now commonplace, can transmit audio and video content to a single home using hundreds of different channels. As another example, the growing popularity of the Internet has resulted in the online accessibility of music, video, and application files. The Internet itself, and the World Wide Web in particular, allows a user to access an almost unlimited number of different web pages identified by a like number of unique uniform resource locators (URLs). In addition, wireless telephones have migrated into flexible communication devices having enhanced features or functions such as web browsers, email, video games, calendar/scheduler, and media player. Indeed, in today's communication-based environment, the lines between previously distinct devices such as personal computers, televisions, video game consoles, wireless phones, personal digital assistants (PDAs), digital media players, home entertainment equipment, and home appliances are becoming increasingly blurred.

New technologies promise to bring a vast assortment of audio and video broadcasts, including movies, news programs, dramatic works, music, sports programs, talk shows, and other content. Such content may be provided from a remote location in the form of streaming media or in the form of a cable or satellite television broadcast. Many cable and satellite television companies also provide a large number of digital music channels to their subscribers; the large number of video and music channels can be overwhelming to many users. Instead of a relatively small number of traditional radio and television stations available in major metropolitan markets or via standard cable or satellite systems, users are presented with thousands of possibilities. Never before has there been such a vast selection of alternatives, with broadcasters providing every imaginable permutation for every conceivable area of interest, from mainstream popular music to the most obscure and unlikely niches.

End users of various devices often have difficulty searching, locating, viewing, and downloading suitable content due to the vast number of content files and/or content sources. For example, the large quantity of available Internet and broadcast stations presents a paradox: while users undoubtedly benefit from the unprecedented number of choices in genre and content which broadcasters provide, they cannot easily and efficiently select from among the hundreds of stations, channels, and/or entities broadcasting a given type of music, video, program, or file. In addition, users cannot identify what is interesting, relevant, or available, or determine the quality of service or other operational parameters of the available broadcasts.

Known solutions utilized by many Internet sites are based on the garden variety search engine interface. In one form of this interface, the user enters a search query (a word or a phrase) and is eventually presented with a multi-page list of hundreds or thousands of possible matches. Alternatively, the user may be shown a hierarchical list of categories, with each category serving as a higher level in the hierarchical display of relevant content. In this manner, the user can continue selecting links to navigate deeper into the hierarchy until he finds a suitable file or link.

Current solutions of cable television set-top boxes and satellite television decoders typically operate in a more primitive manner. Since most of these devices lack a keyboard, they can only display information in a hierarchical format or by showing every available station or channel in a long list. Due to the limited size and resolution of a television screen display, paging through long lists of channels can be a tedious and frustrating process. While this type of interface may arguably be considered adequate in many current environments, it is unsuitable for systems having a very large number of content providers, stations, channels, and/or web site addresses to choose from.

One prior art system is implemented as a stand-alone software application that resides at the end user's computing device. This system utilizes a number of icons categorized together as a planet, where the icons represent links to different web pages or files stored on the computing device. This system maintains no connectivity between the user's computing device and any real-time data maintained by a remote server. Consequently, this system is not capable of providing current programming information related to broadcast content that is available to the end user.

Accordingly, there is a need in the industry for an effective and intuitive system for locating and identifying media and other content, which may be provided by multiple information sources and service providers, via a communication network.

### BRIEF SUMMARY OF THE INVENTION

The present invention provides a system for generating an interactive navigation interface for display at an end user device. In accordance with a preferred embodiment, the end user device merely finctions as a display element; the navigation interface itself is generated, maintained, and processed by one or more remote server components. The navigation interface is configured to allow a user to intuitively, effectively, and easily determine the broadcast status associated with a large number of content providers, channels, stations, web sites, or the like. The navigation interface utilizes a magnification (zoom) feature along with a hierarchical protocol for the display of active map items representing different information sources or programs. In this respect, the navigation interface displays only a limited number of active map items at an initial magnification level and introduces additional active map items as the magnification changes. The interactive navigation interface may include a number of additional features designed to enhance the display of useful information to the user and to make it easier for the user to view and locate appropriate content.

In accordance with another aspect of the present invention, the navigation interface system is configured in a layered architecture. In this manner, the system can be deployed in a centralized mode using remote servers. Various presentation layers associated with different presentation devices are utilized to obtain generic display characteristic data from the remote servers. In turn, the respective presentation layers act as an interface between the generic data and data formatted for compatibility with the presentation devices. Consequently, the system need not employ customized server applications for the different presentation devices.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is an exemplary navigation interface display screen at a relatively low magnification level;

FIG. 2 is the navigation interface display screen of FIG. 1 at a relatively intermediate magnification level;

FIG. 3 is the navigation interface display screen of FIG. 1 at a relatively high magnification level;

FIG. 4 is a schematic representation of a navigation interface display;

FIG. 5 is a schematic representation of a navigation interface display system in which the techniques of the present invention may be implemented;

FIG. 6 is a schematic representation of an exemplary map server architecture that may be utilized in the system shown in FIG. 5;

FIG. 7 is a schematic representation of a personal computer presentation layer;

FIG. 8 is a schematic representation of a cellular telephone presentation layer;

FIG. 9 is a schematic representation of a wireless personal digital assistant presentation layer;

FIG. 10 is a schematic representation of a set-top presentation layer;

FIG. 11 is a schematic representation of a time-shifting element in a first state;

FIG. 12 is a schematic representation of a time-shifting element in a second state;

FIG. 13 is a flow diagram of a navigation map operation process according to one practical embodiment of the present invention;

FIG. 14 is a flow diagram of a user interaction process;

FIG. 15 is a flow diagram of a zoom process according to one practical embodiment of the present invention;

FIG. 16 is a flow diagram of a zoom request process;

FIG. 17 is a flow diagram of a pan request process;

FIG. 18 is a flow diagram of an on-map selection process;

FIG. 19 is a flow diagram of a hovering process;

FIG. 20 is a flow diagram of an activation request process;

FIG. 21 is a flow diagram of a time shifting process;

FIG. 22 is a flow diagram of a directional key request process;

FIG. 23 is a flow diagram of a change selection process;

FIG. 24 is a flow diagram of a navigation map presentation process according to one practical embodiment of the present invention;

FIG. 25 is a flow diagram of a map system request process;

FIG. 26 illustrates a system block diagram of one embodiment of a network system in which the techniques of the present invention may be used;

FIG. 27 illustrates one embodiment of a computer system suitable for use in the network system shown in FIG. 26;

FIG. 28 illustrates one embodiment of a layout of a graphical user interface provided in accordance with the principles of the present invention;

FIG. 29 illustrates one example of the graphical user interface depicted in FIG. 28;

FIG. 30 illustrates one embodiment of a navigator bar used in the graphical user interface of the present invention; and

FIG. 31 illustrates an alternate embodiment of the architecture of a system that implements the principles of the present invention.

### DETAILED DESCRIPTION OF A PREFERRED EMBODIMENT

The present invention may be described herein in terms of finctional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the systems described herein are merely exemplary applications for the invention.

It should be appreciated that the particular implementations shown and described herein are illustrative of the invention and its best mode and are not intended to otherwise limit the scope of the invention in any way. Indeed, for the sake of brevity, conventional techniques for signal processing, data transmission, signaling, network control, and other finctional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

Overview

The present invention provides end users with an interactive navigation interface that makes it easy for the end users to view, search, and locate a plurality of graphical symbols corresponding to different content files, content sources, data, information, web pages, active links, or the like. In practical deployments, the present invention is suitable for use in connection with television programming schedules, streaming media (audio and/or video) broadcast information, web page bookmarking, computer file managing and organizing, or the like. The present invention provides users with a graphical display metaphor that is easy to understand and is capable of organizing and displaying a large amount of information in an intuitive and easy-to-use format. The user's experience is enhanced by displaying the information using a map metaphor that is graphical, dynamic, interactive, and enjoyable to use. The interactive map interface leverages spatial memory to allow users to quickly re-locate media items that they found during a previous viewing.

In lieu of a traditional hierarchical or list-based approach, the navigation interface displays available broadcasters using a graphical map generated in a format suitable for use with the particular presentation device, e.g., a television, a personal computer, a personal digital assistant (PDA), a wireless telephone, or the like. In the preferred implementation, the map features a mythical group of islands, continents, and seas, each with a set of symbols or icons representing available broadcasters, service providers, program titles, files, media items, web site addresses, or the like. In this preferred embodiment, each region on the map is labeled to represent a different genre or category, with related icons or active map items located within the appropriate region. In addition, logical sub-regions represent subsets or subcategories of a genre. For example, one massive island representing sports programming may be identified as “Sports Land.” One portion of this island may be dedicated to baseball, another may relate to golf, and so on.

The navigation map can be displayed in a two-dimensional manner or in a three dimensional perspective, with rolling hills, water, forests, deserts, and other features. The end user can zoom in and out, scroll or pan across the overall map, select an active map item to view additional information regarding the associated content provider, program, or file, and access other related functions. In accordance with one aspect of the present invention, the display is dynamic in that it reflects realtime operating conditions and/or programming characteristics. For example, the appearance of the active map item icons may change depending upon what content is being broadcast, the level of interest to the user, whether the map items are marked as personal “favorites,” or any other criteria.

In the preferred implementation, the interactive navigation map employs a natural hierarchical scheme, which enables it to support thousands of media items without overwhelming the user. An analogy to this map interface is a roadmap where the most important information, e.g., major cities and highways, is displayed prominently and more obscure information, e.g., two-lane roads and small towns, is displayed in a less pronounced manner or perhaps only displayed on a more detailed (or magnified) map view.

A practical implementation of the present invention may reside in a number of software elements that reside at one or more processing locations. In accordance with one preferred embodiment, the software is configured to operate in conjunction with any Java-based web server platform operating open database connectivity (ODBC) or SQL compliant data. This ensures that the back-end is highly scalable, robust, distributable, and easy to maintain. The interactive navigation system is preferably configured such that it is entirely server based and capable of automatically scaling its features to the capability of the client presentation device. Consequently, the end user need not perform any downloading, software installation, or hardware reconfiguring. In addition, ongoing maintenance, changes, and enhancements to the navigation interface system can be centralized at a server and can be made completely transparent to the end user.

The system architecture is also capable of storing end user personalization data in an industry standard SQL data store. Thus, broadcast service providers employing the navigation system can use online analytical processing (OLAP) tools to extract critical demographic data about the end users, thus enabling more efficient marketing, advertising, and programming techniques. Accordingly, in addition to enhancing the users' experiences through pervasive personalization, service providers can learn more about the users' viewing habits and access patterns, which allows the service providers to deliver better services and, ultimately, generate more revenue.

The system architecture may include a server-based map system and any number of presentation layers, where different presentation layers may be suitably configured for compatibility with different presentation devices (cable television settop boxes, personal computers, and the like). In a current implementation of the present invention, the presentation layers support hypertext markup language (HTML), dynamic HTML (DHTML), and PDA (e.g., PALM) web-clipping front ends. Such flexibility enables the presentation layers to work on different web browser applications, including those utilized by many wireless devices, without requiring the downloading of any additional software viewers, ActiveX controls, applets, or other components. The architecture allows for easy adaptation to other display platforms including digital set-top boxes, satellite decoders, video game consoles, wireless application protocol (WAP) devices, and the like.

In addition to the above features, the navigation system may be configured to cooperate with a set of authoring tools to allow the creation and management of navigation maps, XML configuration files to allow easy connection to legacy databases, and utilities to make deployment of maps a simple process. In one practical embodiment, these additional tools may be accessed (via, e.g., the Internet) by the entity that deploys the navigation system architecture. Such tools may communicate with the map system servers in a suitable manner to enable direct customization of interactive map interfaces by the broadcast service providers.

Navigation Interface Display

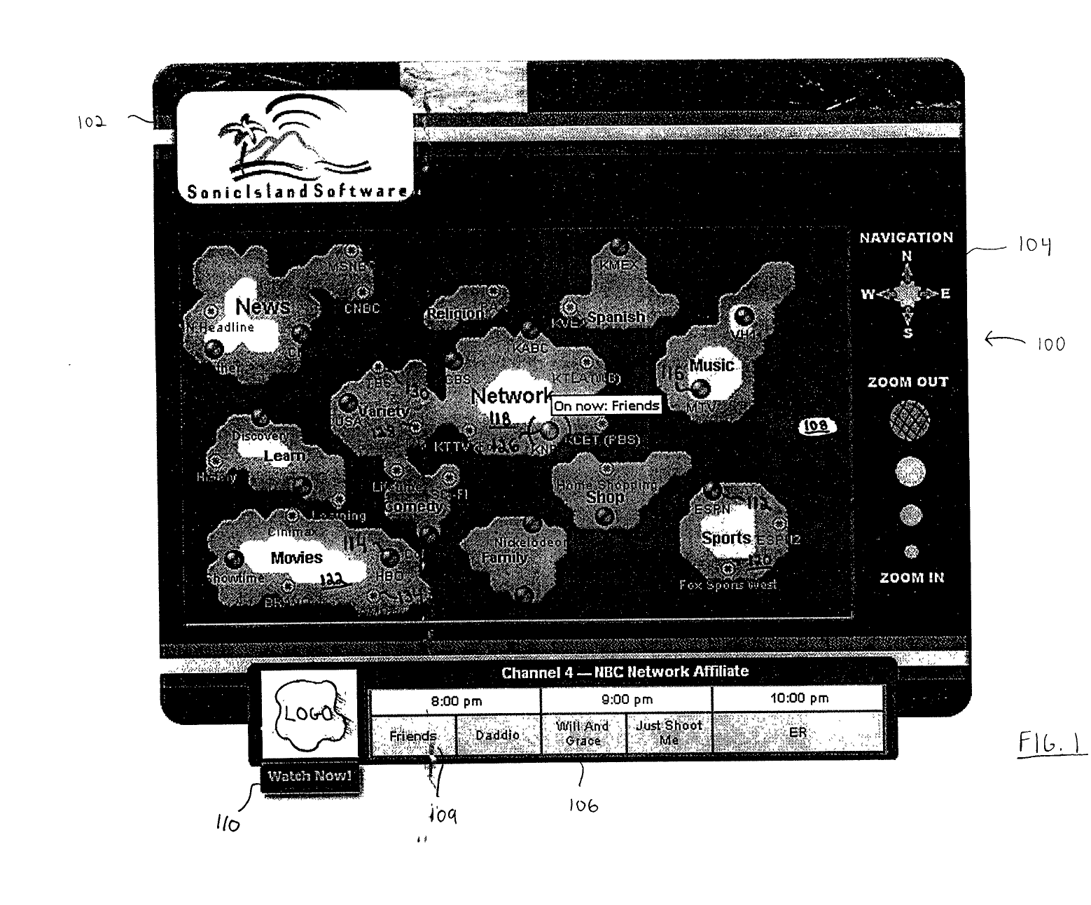

An exemplary navigation interface display screen 100 is depicted in FIG. 1. As described in more detail below, display 100 is preferably generated by a system configured in accordance with the present invention. Display 100 is shown and described herein for purposes of illustration; display 100 is not intended to limit or restrict the scope or applicability of the present invention in any way. Indeed, the specific configuration of display 100 may vary depending upon the particular application, system preferences, user preferences, and/or display device characteristics. For example, any number of the following (and other) features of display 100 may vary from application to application: the layout of the map “geography;” the number or arrangement of the symbols on the map geography; the number or arrangement of descriptive indicia on the map geography; the size or shape of the various display elements; the colors used in display 100; and the type of media, files, or data associated with the control items.

In addition, the characteristics of the navigation interface display 100 may vary to accommodate different presentation devices. For example, display 100 may be suitable for use in connection with a computer and web browser implementation capable of receiving user inputs via a mouse, a trackball, a finger pad, or other pointing device having a substantially continuous cursor rendered on the display screen. An alternate embodiment may utilize a different navigation interface display that is more suitable for use with a remote control device having a limited number of directional navigation buttons (such remote control devices are commonly used to control set-top converter boxes in cable and satellite television systems). Yet another embodiment may utilize a navigation interface display having relatively low resolution and reduced finctionality to accommodate smaller presentation devices such as PDAs or wireless telephones.

Navigation interface display 100 may be subdivided into a number of general elements or components. For example, display 100 may include a title/banner element 102, a navigation bar 104, an information element 106, and a map 108. Title/banner element 102 may be used to identify a service or content provider such as a cable television company, a broadcasting network or media conglomeration, a provider or host associated with the deployment and/or maintenance of the navigation interface display system, a manufacturer of the presentation device upon which display 100 will be rendered, or the like. The specific content of title/banner element 102 may be fixed, selectable, or dynamically variable, depending upon the implementation of the interface display system.

Navigation bar 104, or a functional equivalent, may be integrated into navigation interface display 100 to accommodate presentation devices that have a user-operated cursor rendered on the display screen (e.g., a mouse-driven cursor). In alternate embodiments, the functionality of navigation bar 104 can be included in a remote control device, a keyboard, or as an integrated hardware feature of the presentation device. In the exemplary embodiment shown in FIG. 1, navigation bar 104 includes arrows (or any suitable pan direction control indicators) that can be selected to pan or scroll map 108 in the indicated direction. To aid in the navigation, the arrows may be highlighted in response to the position of the cursor to indicate the selected direction. Navigation bar 104 may also include zoom controls that allow the user to change the level of magnification of map 108. The zoom controls may include indicia representing a discrete number of magnification levels (such as the four circles shown in FIGS. 1-3), indicia representing increasing and decreasing magnification, and/or indicia representing a change in the overall size of map 108. For example, the current zoom level may be indicated by changing the appearance of one of the four circles. The zooming and panning features may be continuous or discrete depending on the specific implementation of the interactive navigation display system, the processing capabilities of the display system, and/or the characteristics of the respective display element upon which map 108 is rendered.

Information element 106 preferably contains “live” or real-time information regarding the currently selected active map item. Such information may change in accordance with variations in the broadcast or programming status, the specific content requested by the user, or any other variable criteria. In various embodiments, the displayed map items may represent any broadcast information, streaming media files, radio programs, television or radio networks, web page bookmarks, URLs, downloadable data files, applets, pay per view programs, video on demand programs, locally recorded videos, video games, chat rooms, e-commerce web sites, home automation systems (including appliances, security systems, and climate control systems), and any combination thereof. Accordingly, the content of information element 106 may vary depending on the particular application, and such content need not be limited to data associated with conventional or Internet-based television, radio, music, or video “stations.”

In accordance with the practical embodiment illustrated in FIG. 1, the displayed map items represent cable television stations. In response to the selection of an active map item or “button” on map 108, information element 106 displays information related to the programming associated with the respective station. In this respect, the selection of an active map item may prompt the display of additional data or cause the navigation display system to perform further related processes. For example, the illustrated information element 106 contains the station (or network) name, a station identifier such as an alphanumeric character string, an icon or logo associated with the station or program, and the name of the program currently being broadcast (identified in the leftmost field 109). Information element 106 may also include a timetable with other program listings and/or a section for displaying a live video feed, e.g., a “picture-in-picture” window. In accordance with one aspect of the present invention, information element 106 includes an active element 110 (such as the “Watch Now” symbol shown in FIG. 1) that, when selected, causes the presentation device (or a device controlled by the presentation device) to display the currently highlighted or featured program.

In addition to the above features, information element 106 (or other elements of display 100) may include any number of features, including: additional pull-down or pop-up information related to the listed programs; VCR or other audio or video recording control; URLs associated with Internet-based content; bandwidth, signal strength, station reliability, or other quality of service parameters related to the transmission of the selected program; popularity ratings for the selected program; the available broadcast technology (which may be displayed iconically) for the selected program or file, e.g., REALAUDIO, QUICKTIME, WMA, MP3, MPEG-2, or the like; polling or rating inputs, which allow the user to rate the station or program; adding web page bookmarks, which allows the user to add the URL for online content providers to the user's web browser; and adding stations to the user's list of “favorites.” Information element 106 may also leverage known program listing technologies and formats to provide a rich and user-friendly navigation experience.

Dynamic Navigation Map

Map 108 is suitably configured to provide the user with programming information in an easy-to-navigate manner. In the preferred mode of operation, map 108 is dynamic in nature. For example, map 108 may include, without limitation, any number of the following features: flashing icons or symbols; pop-up or pull-down icons, tables, text boxes, or labels that are responsive to user commands or to the movement and/or position of a cursor rendered on the display screen; symbols, such as map items, having variable appearances that react to various criteria; program listing and descriptions that change in accordance with the user's navigation of the map; zooming (magnification) capabilities; and panning or scrolling capabilities. In addition, map 108 may be dynamically updated in response to the real-time changes in program listings. As described above, the displayed map items may represent various types of data or information depending upon the particular application of the invention. In this respect, the map items can represent or be associated with broadcast information, streaming media files available on a network such as the Internet, radio programs, television or radio networks, web page bookmarks, URLs, downloadable data files, applets, pay per view programs, video on demand programs, locally recorded videos, video games, chat rooms, e-commerce web sites, home automation systems (including appliances, security systems, and climate control systems), and any combination thereof.

In the preferred embodiment, the zooming feature facilitates the progressive scaling of a displayed map (or a portion thereof) that gives the visual impression of movement of all or part of a display group toward or away from an observer (see the definition of “zooming” contained in the IBM Dictionary of Computing, 8^{th} edition, 1987). In other words, the zooming feature causes the display of the map to change from a distant view to a close view, and vice versa, as though the end user were manipulating a telescope, a magnifying glass, or a zoom lens of a camera. Similarly, the panning feature facilitates the progressive translating of a displayed map (or a portion thereof) that gives the visual impression of lateral movement of the image (see the definition of “panning” contained in the IBM Dictionary of Computing, 8^{th} edition, 1987). These visual characteristics of the navigation map provide a realistic visual simulation to the end user.

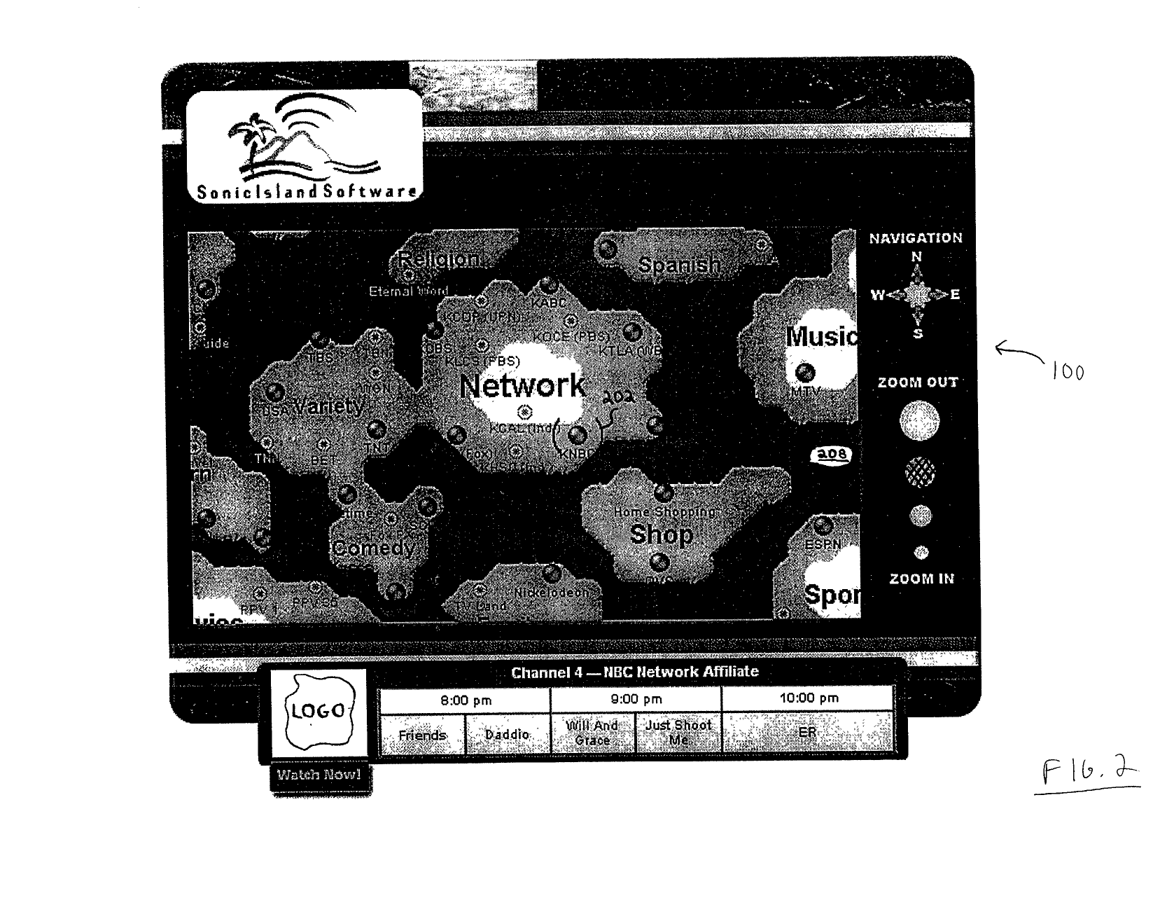

The particular “screen shot” shown in FIG. 1 reflects a moment frozen in time. At this moment, map 108 is associated with a specific magnification level, e.g., the lowest of four discrete magnification levels. At this level of minimum magnification, the entire geography or “world” may be displayed with a limited number of visible and active map items. With brief reference to FIG. 2, the same navigation interface display 100 is shown having a map 208 depicted at a higher magnification level. The maps shown in FIG. 1 and FIG. 2 are two dimensional renderings having three dimensional characteristics such as shading and perspective. Alternate embodiments may utilize three dimensional rendering and appropriate three dimensional navigation capabilities (zooming, panning, rolling, tilting, etc.).

Generally, map 108 may contain any number of distinct graphical features such as geographical land masses, oceans, islands, or continents. Such graphical features may contain streets, cities, buildings, rooms, landscapes, floor plans, and other elements. Of course, navigation interface display 100 need not employ a geographical map analogy; display 100 may utilize any suitable design or graphical features (e.g., labeling, icons, coloring, or grouping of map items) for purposes of categorization and organization of the various symbols that represent the available channels, programs, or files. In the preferred embodiment, a plurality of symbols, rendered as map items, are displayed in a distributed manner over map 108. For example, map 108 includes a map item 112 representing the station ESPN, a map item 114 representing the station HBO, a map item 116 representing the station MTV, and a number of other map items representing other stations or channels. Sets of map items are displayed on or proximate to specific graphical features of map 108 and subsets of map items may be displayed on or proximate to specific areas or regions within one graphical feature.

Each region on map 108 may be labeled to represent a different genre, category, or subject, with appropriate map items displayed on or near a related region. For example, one island 118 includes the label “Network” to identify that the resident map items represent traditional network affiliate stations, such as NBC, ABC, CBS, PBS, and the like. Another land mass 120 includes the label “Sports” to identify that the resident map items represent stations that broadcast sports programming. Yet another graphical feature 122 includes the indicia “Movies” to identify that the resident map items represent stations that broadcast full-length motion pictures. As shown in FIG. 1, map 108 may include any number of labeled regions, such as News, Movies, Family, Comedy, Shopping, and Music. In a practical embodiment, some stations or channels may have duplicate map items associated with more than one region or category.

In accordance with one preferred aspect of the present invention, the map items may dynamically shift on a navigation map depending upon the current subject matter represented by the map items. Thus, a map may exhibit dynamic re-mapping of map items onto different regions in response to programming changes or other criteria. For example, a map item representing the station HBO may appear on the “Movies” region 122 during the broadcast of a movie and automatically shift to the “Sports” region 120 if a sporting event is broadcast after the movie. In addition, different map items may dynamically appear or disappear in response to the characteristics or availability of programming.

As described above, a user can navigate map 108 using navigation bar 104, a remote control device, and/or other user interface devices (e.g., a mouse, a keyboard, a trackball, ajoystick, a touch pad, etc.). In accordance with one aspect of the present invention, map 108 can be navigated and traversed in an intuitive and easy manner. The user may engage navigation bar 104 for purposes of zooming and panning. In addition, the user can direct the displayed cursor to a specific region of map 108 and select that region (e.g., by clicking the mouse button) to center map 108 about that region or to magnify map 108 about that region. For example, the user can select the Sports island 120 to automatically zoom and reposition or re-center map 108 to focus on that region. Such zooming and repositioning may also be controlled by external events that do not require the user to initiate a zoom or re-center command. For example, the interface display system may receive a request to display the region labeled “Movies.” In response, the map 108 may be adjusted to focus on that region. As another example, a user may select a banner advertisement displayed in connection with an application external to the interface display system (such as a web browser). In response to the selection of the advertisement, map 108 can be displayed with an appropriate region (associated with the advertisement) as the central focal point. Embodiments that implement continuous zooming and/or continuous panning may have intuitive navigation capabilities that allow the user to easily pan, zoom, or scroll over map 108 using an interface device, e.g., by clicking and dragging the cursor to reposition map 108.

As described above, many televisions and set-top converters are controlled by remote control devices having limited navigation capabilities (many of these devices merely include four directional control buttons). Traversing through an interactive interface can be difficult with such remote control devices, particularly when the interface display does not contain control points arranged in a grid pattern. In other words, it can be difficult for the user to ascertain which control point will be selected in response to any given directional button.

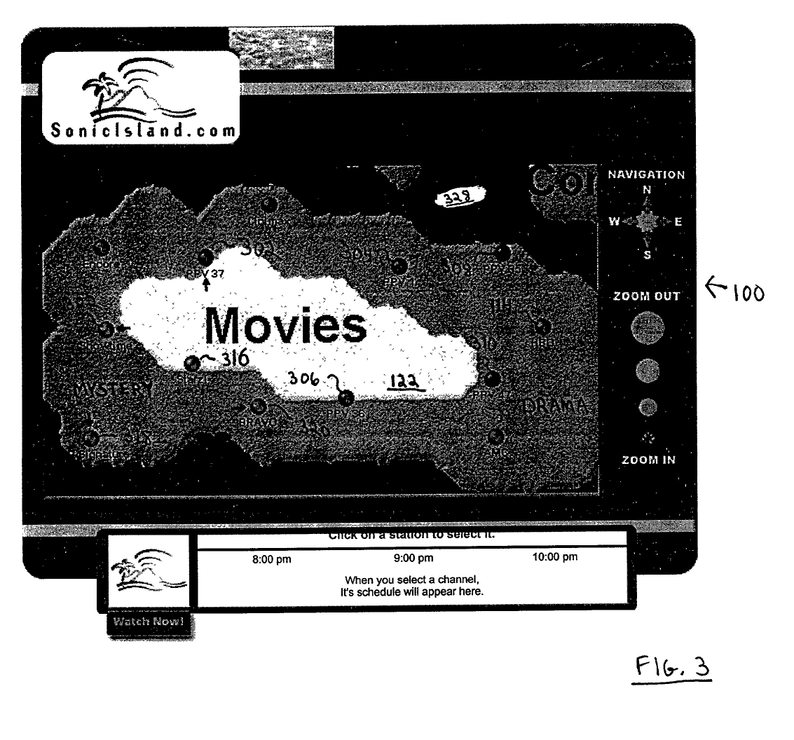

The navigation interface display system of the present invention may be suitably configured to generate guidance indicators on the navigation map. The guidance indicators provide visual guidance to the user, thus simplifying navigation of the map with a user device having limited navigation capabilities. FIG. 3 depicts exemplary guidance indicators rendered in the form of directional arrows. In this example, a map item 316 is the currently selected symbol or the symbol associated with the current position of the user's navigation device. Map item 316 is located in response to user interaction and map item 316 may be highlighted to reflect that it is the current position. As shown in the map 328 of FIG. 3, a number of asymmetrically arranged map items surround map item 316. Map item 302 is associated with an arrow pointing up, map item 318 is associated with an arrow pointing down, map item 320 is associated with an arrow pointing right, and map item 322 is associated with an arrow pointing left. These arrows rendered on the display element provide immediate visual feedback to the user by indicating map items, other than the selected map item, to which the user can move. The navigation indicators are dynamic in nature; they automatically respond to movement of the cursor position by identifying the appropriate neighboring map items.

The correspondence between map items and directional indicators may be determined in a dynamic manner using any number of algorithms designed to find the “closest neighbors.” Such an embodiment would allow automatic adaptation to the addition or subtraction of map items. In an alternate embodiment, the map may be initially designed with such guidance indicators coded along with the map items. This technique may be suitable for use with navigation maps where the number and location of map items are fixed.

It should be appreciated that the number of navigation indicators need not be limited to four and that the present invention may be flexibly configured to accommodate any number of discrete navigation directions. In addition, the navigation indicators need not be rendered as directional arrows. Alternate embodiments may employ any suitable pointing icon such as those rendered for use with a mouse cursor, colored markers, distinguishable icons, or the like. Indeed, some benefits may be derived by merely highlighting or indicating the neighboring map items without specifically identifying the direction of travel required to reach them. Although the guidance indicators are utilized in the context of the navigation interface display system described herein, the technique may be implemented in any number of alternative navigation display systems. For example, the concept of guidance indicators may be employed in the context of video games, interactive DVDs, and other applications that rely on a remote control device having a discrete number of directional controls.

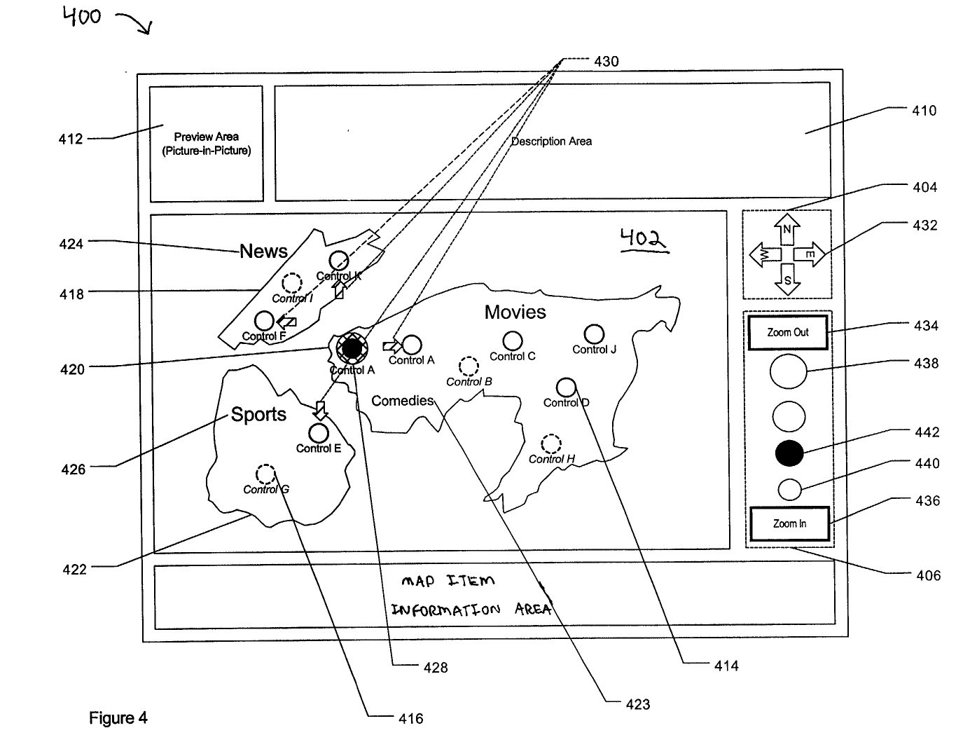

In a practical embodiment, the navigation of the displayed map is responsive to directional control signals, magnification control signals, centering control signals, and other navigational control signals that may be initiated by the user. Such control signals may be directly processed by the respective presentation device or they may be suitably transmitted to a server for central processing and manipulation of the displayed map. The processing of such control signals may be better understood in connection with the description of the hardware and software architecture of the navigation interface display system (see the description associated with FIGS. 4-12).

Hierarchical Map Characteristics

The navigation map is preferably designed to display its features in a hierarchical manner. Briefly, the navigation map exhibits a hierarchical categorization scheme associated with the grouping of the map items and a hierarchical visibility scheme associated with the display of active map items. Both of these hierarchical schemes will be described in detail with reference to FIGS. 1-3.

As described above, individual map items are preferably grouped according to a number of specified categories. Graphical features (the land masses in FIGS. 1-3) associated with the categories are displayed along with indicia representative of the genre or category. At a relatively low level of magnification (see FIG. 1), the preferred embodiment of the present invention displays broad categories such as Movies, News, and Sports. Those map items located on or proximate to a given geographical feature represent programs or stations that are generally related to that category. Thus, all of the map items contained on or near graphical feature 122 are associated with movies. In contrast, at a relatively high level of magnification (see FIG. 3), a given category may be further divided into one or more subcategories. In this respect, a first number of active map items from the general category are displayed on or proximate to a first area of the graphical feature and a second number of active map items may be displayed on or proximate to a second area of the graphical feature. In the context of FIG. 3, the general category of “Movies” includes the subcategories of “Mystery” and “Drama.” Map items located near to the “Mystery” label represent mystery movies, while map items located near to the “Drama” label represent dramatic movies. Although not depicted in FIG. 3, the navigation map may display separating lines or zones to designate the different subcategory areas of the respective graphical feature. In addition, any number of subcategories may be displayed at any given zoom level.

The map display may also support a “show category” feature. This feature allows a user to select an individual category (usually via a menu, a hot key, the selection of an icon, or other functionality) while using the system. In response to the identification of a category (or subcategory), the magnification, panning, and/or other display characteristics of the map may be adjusted to focus on the selected category. When this feature is invoked, the selected category is displayed near the center of the display element and, preferably, at the maximum possible magnification that allows all of the respective map items to be shown. In a practical embodiment, the map system may store a “boundary region” for each category and/or subcategory, where the boundary region represents the maximum extent of the category. For example, FIG. 3 represents an exemplary display that may be generated in response to the selection of the “Movies” category. In an alternate embodiment, the “show category” feature may highlight the selected category or change the appearance of graphical features and items outside of the category (e.g., by shading, coloring, dimming, or darkening such graphical features). The “show category” capability allows the user to quickly and easily view a desired category without having to pan, zoom, and otherwise traverse the map.

As the level of magnification increases, the level of detail on the navigation map may also increase. Thus, additional subcategories (and lower order subcategories) may begin to appear at higher magnification levels, along with additional map items associated with the various subcategories. As more subcategories appear, the corresponding labels or other indicia of such additional subcategories may also appear on the respective area of the graphical land mass feature. This hierarchical display of categories, subcategories, and respective grouping of map items allows the user to easily and intuitively locate and select appropriate programs by genre.

It should be appreciated that, in addition to categorizing by geographic area, the navigation map can also categorize map items in a hierarchical manner using any desired criteria. For example, as shown in FIG. 3, each of the map items 302, 304, 306, 308, and 310 include the label “PPV” to identify that those stations are pay per view stations. In the preferred embodiment, these map items are further distinguished from other map items by use of a different color (green indicates a free station and red indicates a pay per view station). The use of distinct labeling and distinct coloring in this context is akin to a sub-categorization scheme. Furthermore, because these pay per view map items may not be visible at a relatively lower magnification level (see FIG. 1), their display follows the hierarchical protocol described above in connection with the subdivision of the graphical features and the display of subcategory labels.

With respect to the hierarchical visibility scheme, a relatively limited number of map items are displayed at the lowest magnification level (see FIG. 1). In contrast, as the magnification level increases (see FIG. 2 and FIG. 3), more map items become visible and more map items become active. In the example map 108 shown in FIG. 1, the Network feature 118 includes five active map items, each of which is represented by a round, three-dimensionally shaded button. One of the active map items, identified by reference number 126, represents a currently selected or highlighted symbol. The remaining active map items on Network feature 118 (and on the other graphical features shown in FIG. 1) may be selected by the user such that the related programming information can be displayed in information element 106 and/or in a pop-up window in map 108.

At higher magnification levels, the number of active map items associated with a given region or category increases because active map items displayed at relatively lower magnification levels remain displayed at higher magnification levels. In this respect, the active map items associated with a relatively lower magnification level is a subset (preferably a proper subset) of the active map items associated with a relatively higher magnification level. Accordingly, the number of active map items associated with a relatively higher magnification level will be greater than the number of active map items associated with a relatively lower magnification level.

In accordance with a preferred aspect of the invention, a number of inactive map items may also be displayed at any given magnification level. For example, Network feature 118 includes seven inactive map items displayed at the level shown in FIG. 1. The inactive map items include a map item 128 representing the station TNT and a map item 130 representing the station TBS. Although the inactive map items are displayed, they have limited or no functionality. For example, inactive map items may not be selectable by the user and they may not convey any information other than the information contained in the actual rendering of the inactive map item. In the preferred embodiment, the inactive map items are rendered on the display element in a visually distinguishable manner relative to the active map items. For example, as shown in FIG. 1, the inactive map items are smaller than the active map items and the inactive map items exhibit a faded or transparent characteristic relative to the active map items. As used herein, “visually distinguishable” may relate to a different size, shape, color, shading, font, design, or other perceivable trait.

The inactive map items at a given magnification level may identify those map items that will become active at a higher magnification level. For the illustrated example that employs discrete levels, the inactive map items displayed in map 108 (see FIG. 1) become active map items in the next highest magnification level displayed in map 208 (see FIG. 2). In addition, a number of new inactive map items become visible in map 208; these inactive map items will become active map items at the next highest magnification level. In an alternate embodiment that uses a “continuous” zoom feature, a given map item may become active at a certain magnification point and remain active if the magnification remains substantially constant or if the magnification increases. The display of such inactive map items allows a user to anticipate the programming information that will become available in response to increased zooming.

The order in which categories and subcategories are displayed in response to magnification changes, the order in which active and inactive map items are displayed in response to magnification changes, and the selection of which map items (active or inactive) are displayed at the lowest hierarchical magnification level may follow any suitable prioritization scheme or metric. For example, the prioritization metric can be based on the frequency of selection of the map items by a user, thus resulting in frequently accessed map items being displayed at the lowest magnification level and less frequently accessed map items being delegated to relatively higher magnification levels. In an alternate embodiment, the prioritization scheme may be based on specified preferences that can be entered by the end user or by the service provider responsible for the maintenance of the navigation display system. This feature allows the service provider to highlight certain broadcasters, networks, genres, or categories in accordance with targeted marketing or focused programming. This feature also allows the end user to monitor or restrict access to certain programs, stations, or programming genres (e.g., in the context of a “parental lock” system). The prioritization scheme can be dynamically responsive to use patterns or programming changes in a manner that facilitates automatic updating of the navigation map characteristics. For example, if a user frequently visits a station, then that station will eventually move up in priority until it becomes displayed at the lowest magnification level and at each higher level.

Dynamic Map Item Appearance

In accordance with another preferred aspect of the present invention, the active map items (and/or other icons displayed on the navigation map) can be rendered in various ways to convey useful information to the user in an easy-tointerpret manner. In this respect, the map items may have at least one variable characteristic associated therewith. The map item appearance may be dynamically responsive to real-time changes in system status, user preferences, the current operating conditions related to the information source corresponding to the map item, or the like. For example, different colored map items may represent different types of programming genres, different programming characteristics, different transmission specifications, or the like. The appearance of the map items may also be altered according to any of the following characteristics: broadcast status, i.e., whether the station is currently broadcasting a program; quality of service; connection bandwidth; service conditions; time until the start of the program (e.g., a rendering of a clock face); the program name; the status of an intelligent home appliance; other programming information; etc. One or more of the following map item icon characteristics may be varied in a dynamic manner: shape, size, color, design, orientation, text label, visibility factor, motion, etc.

In a practical embodiment, flashing red arcs surrounding an active map item indicate the current selection (see reference number 202 in FIG. 2). As described in connection with FIG. 3, one preferred embodiment displays red colored active map items to represent pay per view stations and green colored active map items to represent free stations. Alternatively, the design of the map item icon itself (e.g., a dollar sign) may be used to designate pay per view stations. As mentioned above, colored map item icons represent active map items while gray or “transparent” map item icons represent inactive map items. In addition, a pop-up text box may appear proximate an map item when the user approaches the map item with the cursor or other pointing device. The pop-up box may identify dynamically changing information such as the current program, song title, or file name associated with that active map item. As an example, active map item 126 is shown with an associated pop-up text box that reads “On now: Friends” (see FIG. 1).

The dynamic appearance feature described above in connection with the map items may also apply to text labels (or other information) that accompany the map items. As described above, map items are preferably displayed along with an indicator of the respective stations, networks, or the like. For example, one practical embodiment utilizes fixed labels, e.g., “MTV” for active map item 116 and “ESPN” for active map item 112. However, in an alternate embodiment, such labels may be dynamically configured to provide real-time programming, operating, or status information, such as the title of the program being broadcast, the time until broadcast, the time remaining in the program, the type of program, or the quality of service for the transmission of the program. The labels may also exhibit variable colors, fonts, styles, and other formatting. In a practical embodiment, the interface display system employs a subset of HTML to define the appearance of a given label. In this manner, HTML-like tags may be used to describe the appearance of a label.

FIG. 4 is a schematic representation of an exemplary navigation interface display 400 that includes many of the elements described above. FIG. 4 depicts an alternate format that may be employed in lieu of the format shown in FIGS. 1-3. Briefly, interface display 400 includes a map 402, a navigation control tool 404, a zoom control tool 406, a map item information element 408, a content description element 410, and a preview (or picture-in-picture) area 412.

Map 402 includes various features, elements, and characteristics described above in connection with FIGS. 1-3. For example, map 402 includes a number of active map items or control points 414 and a number of inactive map items or control points 416. As described above, the map items are preferably located on or proximate to a number of regions, e.g., a news region 418, a movies region 420, and a sports region 422. In addition, a region may include sub-regions associated with subcategories, e.g., a comedies sub-region 423 within movies region 420. The regions may be identified by a suitable label located on or proximate to the respective region, e.g., the “News” label 424 and the “Sports” label 426. When an active map item is selected by the end user, the system may generate a suitable selection graphic and/or change the appearance of the selected map item such that the selected map item is visibly distinct from the remaining map items. FIG. 4 depicts one such selected and active map item 428. In response to the selection of a particular map item, a number of guidance indicators 430 may be rendered on map 402. As described above, a practical embodiment generates a separate indicator representing up, down, left, and right directional controls.

Navigation control tool 404 may include any number of direction control elements 432, such as the North, South, East, and West arrows shown in FIG. 4. Zoom control tool 406 may include any number of elements for controlling and/or indicating the zoom level for map 402. For example, zoom control tool 406 may include a decrease zoom level (or zoom out) control element 434, an increase zoom level (or zoom in) control element 436, and any number of selectable elements representing specific zoom levels, e.g., a minimum zoom level element 438 and a maximum zoom level element 440. In the preferred embodiment, zoom control tool 406 highlights or otherwise indicates the current zoom level of map 402 (as depicted by the darkened current zoom level element 442).

Map item information element 408 may include information or data relating to the currently selected map item. As described above in connection with information element 106, element 408 may include past, present, and/or future broadcasting information for the selected station or channel. In contrast, content description element 410 may display information or data relating to the particular content available at the current time on the selected station or channel. For example, while map item information element 408 may display a programming schedule for a television station, content description element 410 may provide information related to the current program on that television station. In this respect, content description element 410 may provide a summary of the program or media being broadcast, the broadcast time, or the like.

As described above, preview area 412 enables end users to experience the content currently associated with the selected map item. If the content is a video program or an image, then preview area 412 may be configured as a small display screen. If the content is an audio clip, then preview area 412 may be inactive or it may display audio control elements or any visual image while the audio plays.

General System Environment

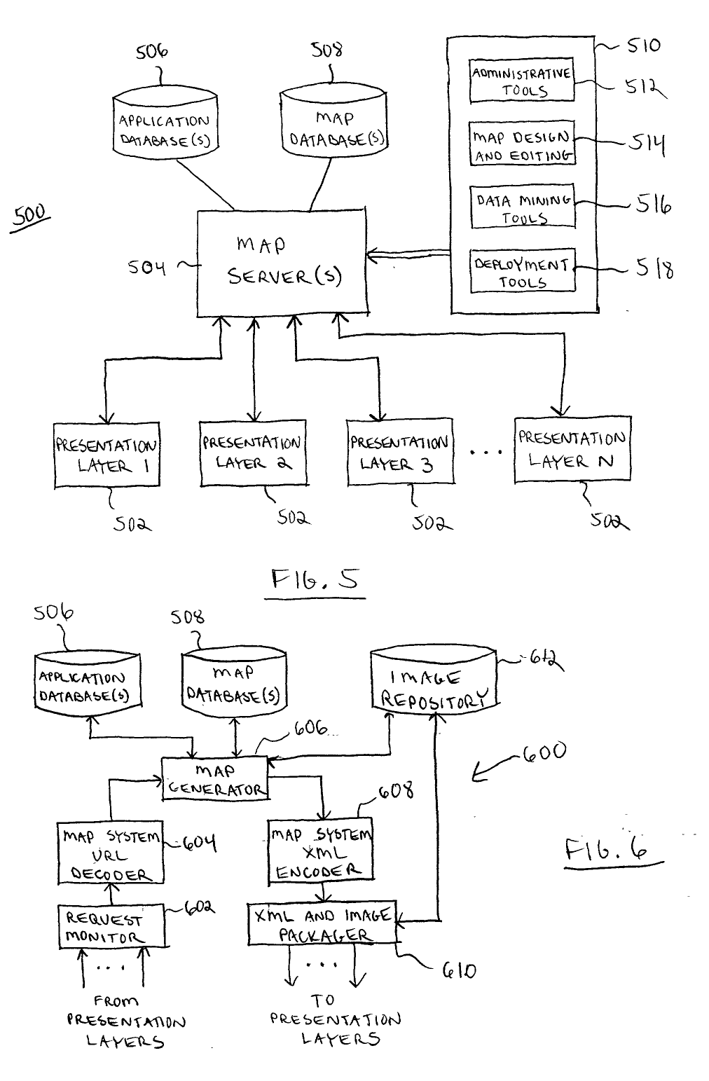

FIG. 5 is a schematic representation of a navigation interface display system 500 in which the techniques of the present invention may be implemented. System 500 is suitably configured to produce, maintain, update, and control the navigation interface display and the dynamic maps described above. System 500 is depicted in a generalized manner to reflect its flexible nature and ability to cooperate with any number of different communication systems, service providers, and display devices. System 500 may include any number of presentation layers 502 (each preferably having an associated presentation device, display element, and application server), one or more map servers 504, one or more application databases 506, one or more map databases 508, and a suite of producer tools 510. In the context of FIG. 5, and for purposes of the example embodiment described herein, system 500 is associated with a particular system administrator, e.g., a cable television provider. Accordingly, some of the elements shown in FIG. 5 may be owned and/or maintained by the service provider.

As used herein, a “server” refers to a computing device or system configured to perform any number of functions and operations associated with navigation interface display system 500. Alternatively, a “server” may refer to software that performs the processes, methods, and/or techniques described herein. From a hardware perspective, system 500 may utilize any number of commercially available servers, e.g., the IBM AS/400, the IBM RS/6000, the SUN ENTERPRISE 5500, the COMPAQ PROLIANT ML570, and those available from UNISYS, DELL, HEWLETT-PACKARD, or the like. Such servers may run any suitable operating system such as UNIX, LINUX, or WINDOWS NT, and may employ any suitable number of microprocessor devices, e.g., the PENTIUM family of processors by INTEL or the processor devices commercially available from ADVANCED MICRO DEVICES, IBM, SUN MICROSYSTEMS, or MOTOROLA.

The server processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, the operating system programs and any server application programs reside in the permanent memory and portions thereof may be loaded into the system memory during operation. In accordance with the practices of persons skilled in the art of computer programming, the present invention is described below with reference to symbolic representations of operations that may be performed by one or more servers associated with system 500. Such operations are sometimes referred to as being computer-executed. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention are essentially the code segments that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

As used herein, a “presentation device” is any device or combination of devices capable of generating a visible display on an associated display element. For example, a presentation device may be a television set, a set-top box or converter associated with a television monitor, a personal computer, a video game console, a wireless telephone, a PDA, a remote control device, a home appliance, a car stereo component, a global positioning system (GPS) receiver, or the like. Presentation devices are preferably configured in conventional ways known to those skilled in the art. In addition, presentation devices may be suitably configured to function in accordance with certain aspects of the present invention, as described in more detail herein. For the sake of clarity and brevity, conventional and well-known aspects of such presentation devices are not described in detail herein.

A respective display element may be integral to a presentation device (e.g., a cellular telephone display screen) or a separate component in communication with presentation device (e.g., a television monitor connected to a set-top converter). The specific configuration and resolution of the display elements may vary according to the type of presentation device that it cooperates with. For example, display elements may utilize cathode ray tube (CRT) technology, touch screen technology, liquid crystal display (LCD) technology, plasma display technology, or the like. In a practical application, a PDA display (such as those utilized by devices manufactured by PALM, INC.) have a resolution of 155×144 pixels with four shades of gray. On the other hand, a WAP-enabled phone (such as the ERICSSON R320) may have a screen resolution of only 101×52 black and white pixels. Most personal computers display 800×600 pixels with 24-bit color, and many of these systems include onboard 3-D acceleration hardware.

In the preferred embodiment, navigation interface display system 500 is capable of supporting a plurality of different presentation devices in a simultaneous manner. In practice, a single user may utilize a plurality of presentation devices in conjunction with navigation interface display system 500. For example, a person may use a set-top converter for television programming, a cellular telephone, and a PDA. System 500 is capable of supporting the integrated use of such multiple devices in a manner that enables the user to access and control different devices and equipment via the presentation devices. For example, system 500 may be configured to allow a user to view television broadcast listings and enter video recording programming instructions remotely from a PDA. In another practical example, system 500 may be configured to allow a user to remotely control home entertainment equipment and home network components (e.g., intelligent household appliances) with a single presentation device. Alternatively, in a simple implementation, system 500 can be configured to only support one presentation device, e.g., a set-top box for use with a cable television system. In addition, system 500 is preferably configured to support a plurality of end users, each of which may have personal data or individual preferences and display settings associated therewith. In this respect, system 500 may be deployed by a cable television service provider having a large number of subscribers in a given locale. The different subscribers will likely have different presentation devices, different programming packages, and different user preferences; these userspecific characteristics may be suitably stored and managed by system 500.

Navigation interface display system 500 can support any number of presentation layers and any number of presentation devices. For example, one presentation layer may represent a web browser implementation, one presentation layer may represent a wireless or cellular telephone implementation, one presentation layer may represent a PDA implementation, one presentation layer may represent a cable or satellite television implementation, and the like. A number of different presentation layers are described in more detail below.

Map servers 504 are generally configured to dynamically produce generic or universal representations of navigation maps according to the techniques of the present invention. As described in more detail below, map servers 504 utilize generic map format descriptors, which enable the different presentation layers 502 to suitably generate the graphical navigation maps according to the characteristics and specifications of the particular presentation devices and the associated display elements.

Map servers 504 preferably communicate with one or more application databases 506, which may be external to the overall architecture of system 500. Application databases 506 are respectively associated with the presentation systems corresponding to the presentation devices 502. For example, system 500 may operate in cooperation with a cable television application database, a wireless telephone application database, a PDA application database, an Internet-based streaming media application database, and other application databases. Application databases 506 are preferably configured to communicate with map servers 504 via TCP/IP in accordance with known techniques. In a practical embodiment, application databases 506 may be realized as conventional SQL databases, e.g., ORACLE-based databases.

The individual application databases 506 preferably contain broadcast and programming information such as cable television listings, available streaming audio/video files, wireless service features, web page bookmarks, and the like. The data stored in the various application databases 506 may include, without limitation, any of the following: (1) radio station (traditional or online) information, which may include station names, URLs, physical locations, current songs being played, uptime history, current status, encoding format (REAL AUDIO, MP3, WMA, etc.), and network affiliations; (2) television station (traditional or online) information, which may include station names, URLs, physical locations, current programs being broadcast, viewer maturity ratings (TV-Y, TV-14, TV-MA, etc.), encoding format (normal, high definition, Dolby stereo, etc.), network affiliations, pay per view pricing, subscription packages capable of receiving the broadcast, current status, program start/end times, and program descriptions; and (3) user information, which may include names, email addresses, account information (credits available, subscription packages, etc.), and preferences. In a practical system, the individual content providers and service providers will be responsible for updating and maintaining the data stored in application databases 506.

Map servers 504 may also communicate with one or more map databases 508, which may be considered to be part of system 500. Map databases 508 may store user preferences related to the navigation interface display, security information, station or channel lists, and other information specific to the particular service provider's implementation of system 500. Map databases 508 may also contain data related to: the visibility of map items (which may be stored on a per-user basis); the location of map items (which may be stored on a per-user basis); virtual image identifiers corresponding to map items; images for the maps; 3-D meshes for the maps; images for map items; 3-D meshes for map items; labels for map items; and the like. As with application databases 506, map databases 508 may communicate with map servers 504 via TCP/IP, and map databases 508 may be configured in accordance with known database technologies.

Producer Tools

Producer tools 510 are generally related to the design, modification, and deployment of the navigation map interfaces. Producer tools 510 may also be related to administrative and monitoring tasks associated with the operation of system 500. Producer tools 510 are configured as software applications that enable the deploying entity to manipulate and customize the characteristics of system 500. In one embodiment, a number of producer tools 510 are network-based, i.e., the respective applications are accessible by service providers to enable system 500 to implement customizations via map servers 504. In a practical deployment, producer tools 510 may be accessed via a standard web browser program such as INTERNET EXPLORER from MICROSOFT. Alternatively, a number of producer tools 510 may be stand-alone software applications that can be used to modify and customize certain aspects of system 500 in an “offline” manner. Such modifications and customizations can be subsequently uploaded to map servers 504 for implementation.

The producer tools may include, without limitation, administrative tools 512, map design and editing tools 514, data mining tools 516, and deployment tools 518. Any of the producer tools may be manipulated by the entity responsible for the deployment, maintenance, and/or administration of the navigation interface display system 500 (the “system administrator”), a hosting entity, end users, network administrators, content providers, and/or any user having authorized access to the tools. Generally, the producer tools may be utilized to: design and configure the navigation maps; to monitor the status of the system; to analyze user data; and to manage the number of navigation maps supported by the system. In a practical embodiment of the present invention, the producer tools are configured as one or more software applications that are accessible by the system user. In this respect, the producer tools may be realized as one or more applications resident at map servers 504, at a service site (not shown in FIG. 5) associated with the system user, at a service site (not shown in FIG. 5) associated with a hosting entity, at a presentation device 502, at a local stand-alone computing device associated with the system administrator, or at any suitable processing location operatively coupled to the navigation interface display system 500.

In accordance with one preferred embodiment, the producer tools are Internetbased, i.e., administrators of display system 500 can access and utilize the producer tools via an appropriate web site maintained by a third party host. Accordingly, in such an embodiment the producer tools need not be deployed as an integral part of map servers 504 or in combination with any other portion of display system 500. In an alternate embodiment, any number of the producer tools can reside on map servers 504. If the producer tools are realized as stand-alone applications, then the administrator of display system 500 can manipulate various parameters, settings, and characteristics of the navigation maps (and/or map servers 504) in a local processing mode divorced from the operation of display system 500. Thereafter, any files, data, settings, or changed parameters can be communicated in any suitable manner to map servers 504 for implementation.

Map design and editing tools 514 are preferably configured to allow the administrator of display system 500 to generate initial (or revised) parameters and characteristics of the navigation maps maintained by display system 500. For example, for a given navigation map, the tools 514 may be used to select (or modify) the graphics, appearance characteristics, text, geographical features, colors, hierarchical arrangement of map items, display preferences, arrangement of displayed elements of the navigation display, and other features. After map design and editing tools 514 have been used to generate a navigation map, the applicable map data is suitably copied to map servers 504. In a practical embodiment, the generic map data is represented by XML data files, image files (at various resolutions and color depths), and/or 3-D meshes. As described above, map design and editing tools 514 are preferably configured to represent the navigation maps using a generic or universal format recognized by map servers 504.

Deployment tools 518 enable the system administrator to initiate use of navigation maps after they have been finalized by the map design and editing tools 514. In operation, a system administrator may use deployment tools 518 to: verify the integrity of the designed maps and map items to be copied onto the map system; copy images, 3-D meshes, and other data to the map servers 504; and copy map item information into the map database 508 (which may include creating the appropriate database tables and indices, assigning zoom levels to map items, and copying default values to user preferences).

After deployment of a navigation map (preferably via deployment tools 518), the system administrator can utilize administrative tools 512 to perform various tasks associated with the operation of navigation interface display system 500. For example, administrative tools 512 are preferably configured to enable the use of filters for purposes of hiding or highlighting certain map items (or for regulating content that may be accessed via the navigation map). Administrative tools 512 also allow the system administrator to monitor the real-time status of the display system 500, including patterns of use by the individual end users. Administrative tools 512 may also be configured to accommodate any number of system control, system monitoring, network signaling, system regulation, and other features that may be desirable from a system administrator standpoint.

As described above, navigation interface display system 500 is preferably capable of gathering and processing data associated with end user preferences and use patterns. Accordingly, data mining tools 516 are suitably configured to extract, format, and otherwise process data associated with the use of display system 500. For example, data mining tools 516 may be accessed by a system administrator to estimate actual viewer or listener ratings regarding the overall popularity of certain broadcast stations. Data mining tools 516 can be configured to generate reports, charts, spreadsheets, and other documents that convey the desired information. In one embodiment, data mining tools 516 may be employed to provide information to map servers 504 such that one or more navigation maps can be modified in real-time to reflect current end user preferences.

Server Interaction with Presentation Layers

Although not a requirement of the present invention, the preferred embodiment of navigation interface display system 500 integrates the graphical interface operation with a server or a set of servers to enable additional functionality beyond that which would otherwise be associated with a stand-alone interface application resident only at the presentation device. The server-based implementation allows information to be displayed at the presentation devices in response to real-time changes in programming, broadcast, or network status (or in response to any changes in system 500), via continuous or intermittent updates from one or more servers. In addition, the presentation devices, the navigation interface display, and/or other devices within an end user's control can be monitored, reconfigured, or controlled indirectly by one or more servers or by other devices such as web browser applications. Furthermore, the server-driven interactivity allows a service provider or an end user to remotely add functionality to the navigation interface display (e.g., adding, removing, or moving map points, changing the appearance of the displayed map, or changing the appearance of the map points).

In the preferred embodiment, each of the presentation devices is associated with a presentation layer 502 that is responsible for the generation of the navigation maps for display on the particular presentation device. In this respect, a television can interact with a set-top presentation layer, a cellular telephone can interact with a cellular telephone presentation layer, a PDA can interact with a PDA presentation layer, and a personal computer can interact with a web browser presentation layer, and so on. Although not shown in FIG. 5, each of the individual presentation layers 502 may be associated with an application server that corresponds to the particular presentation system. Indeed, a presentation layer 502 may include any number of physical components that cooperate to display navigation maps on the respective display element. Depending upon the particular presentation device, a presentation layer 502 may include software components residing at the respective application server, the presentation device itself, and/or at other hardware elements of the system. In addition, the “presentation layer” could be the device itself, e.g., a device may be solely designed to display navigation maps according to the present invention.

In operation, a presentation layer 502 can request a specific navigation map from map servers 504 by designating a URL associated with that map. In response, the map servers 504 generate or retrieve the navigation map and make it available for remote viewing by the end user (e.g., via the Internet) or for downloading to the presentation device. In this manner, map servers 504 can support any number of different navigation map layouts associated with different end users and/or different presentation layers 502.

In a typical case, a URL describes a map for loading by the presentation layer 502. For example, the following string is a request to a map system located at map.sonicisland.com for the “tvislands” map:

Map://map.sonicisland.com/tvislands The URL can contain additional parameters that allow more specific requests related to portions or areas of the map:

Map://map.sonicisland.com/tvislands′1=0?r=1000?t=100?b=500?z=2?uid=name

This sample URL requests the portion of the “tvislands” map in the coordinate range (0, 100)−(1000, 500) at the second zoom level. The map is associated with the person or entity identified by the “name” designator. Of course, these URLs are merely examples of suitably formatted strings. The actual URL formatting may vary from system to system.

As described herein, URLs preferably identify navigation maps in a generic manner recognized by the map servers 504. In this respect, the map system need not be aware of the source of the URL; the map servers 504 may respond to the URL request by providing the appropriate generic map data back to the presentation layer 502 that originated the request. Accordingly, generic map URL may be sent to a user via an email, a text message, or the like. That user may enter the URL into a suitable application program (such as a web browser) or select the URL if it is rendered in the form of a hyperlink. In response, the map servers 504 provide the generic map data to the appropriate presentation layer 502, which formats the map data for display at the user's presentation device.

In response to the request, the presentation layer 502 receives generic map data that describes the requested map. In one practical embodiment, the generic map data is transferred in the form of an XML file (the specific format of this file may vary depending upon the particular system deployment). The generic map data includes details about the requested map area, e.g., the map items at the particular zoom level. The presentation layer 502 may also request map images, map item images, and other features for display.

Map Server Architecture

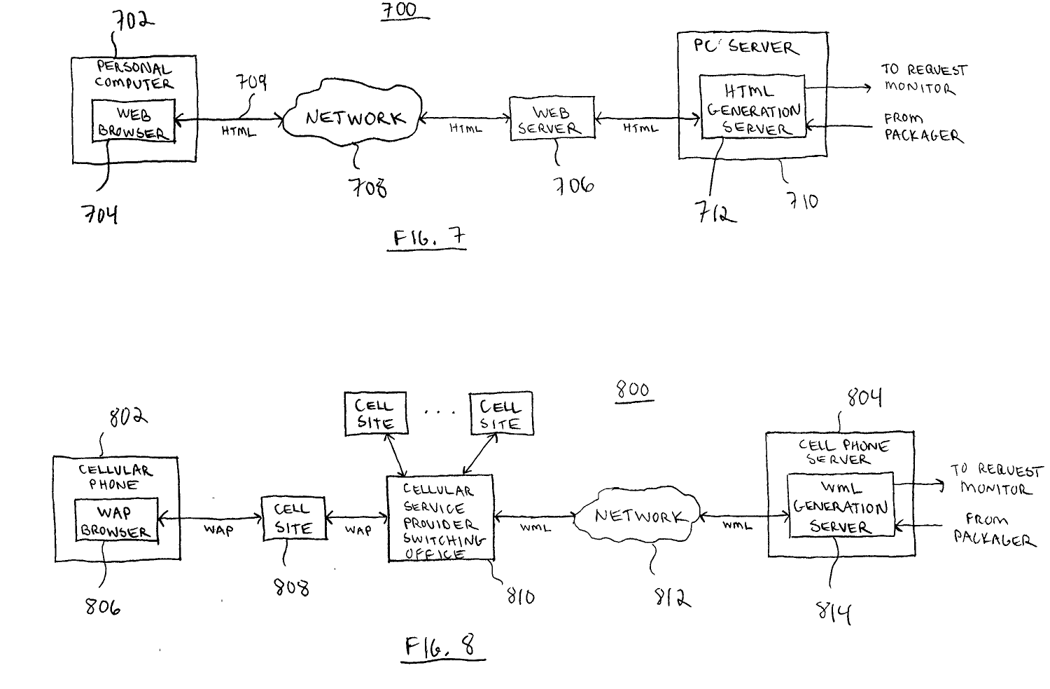

FIG. 6 is a schematic representation of an exemplary map server architecture 600 that may be utilized in the system shown in FIG. 5. It should be appreciated that FIG. 5 depicts merely one suitable map server arrangement; a practical embodiment can include any number of additional or alternative fimctionality. For consistency, application databases 506 and map databases 508 are also shown in FIG. 6.

Map server architecture 600 may be configured to suitably receive and monitor requests generated by the various presentation layers (see element 602). As shown in FIG. 5, map servers 504 are preferably configured to receive requests from different presentation layers and different presentation devices. The requests may include map requests represented by suitable identifiers such as URLs. In accordance with a preferred practical embodiment, map server architecture 600 includes a map system URL decoder 604, which decodes the received URLs for purposes of identifying and generating the corresponding maps.

A map generator 606 receives the decoded data from decoder 604 and interrogates application databases 506 and/or map databases 508 to generate a suitable map (preferably using generic map data as described above). A map system XML encoder 608 processes the output of map generator 606 to suitably transform the map data into XML format. The XML map data and any number of images stored in an image repository 612 are arranged in a packager 610 for communication to the respective presentation layers. In the preferred embodiment, the image repository 612 is a database containing bitmap images and three-dimensional meshes related to individual map items, map labels, selection graphics, and other graphic elements which appear on the maps. In this respect, image repository 612 may be configured as a data store containing all of the image content (map item icons, the representation of geographical features, and the like) that appears on each map generated by the system.

The packager 610 is configured to combine the XML files generated by the map system XML encoder 608 and images (such as map items) from the image repository 612 into a single data package which can be sent to the presentation layers. In other words, the output of the map system XML encoder 608 may be considered to be a generic description of the requested map minus the actual image data; the packager 610 combines the generic description with the image data into one file. In this manner, map servers 504 are able to receive map requests from the presentation layers 502, generate the corresponding map data, and transmit the map data and associated images back to the respective presentation layers 502.

The use of the layered architecture described above is desirable to allow one navigation interface display system to display common information on multiple presentation devices. In view of the different technologies available to an end user, e.g., the different ways to establish a connection with map servers 504, the different levels of security, the different connection speeds, the different display elements, and the like, a practical system should be capable of supporting multiple interface configurations. In this respect, navigation interface display system 500 is suitably configured to support a variety of different technologies, which are enabled based on the capabilities and specifications of the presentation devices and/or the preferences and desires of the end user. The display system 500 is preferably configured to automatically detect the capabilities of a particular end user presentation device and to “gracefully” or “seamlessly” reconfigure or reformat the navigation map rendering to provide the end user with an optimized experience.

To accommodate the different presentation device configurations, display system 500 may simply utilize the appropriate presentation layer. In the preferred embodiment, only the individual presentation layers 502 vary from application to application; the centralized server-based map system remains “generic” in nature. For example, a portable wireless device such as a PDA may display a low resolution, two dimensional, gray-scale version of a navigation map. In contrast, a personal computer having a high speed connection and an advanced processor may display a fully rendered, three dimensional, high resolution color version of the same map. The flexible use of presentation layers is also advantageous from an upgrading standpoint. For example, display system 500 can be easily upgraded by adding presentation layers to support new presentation devices as they become available.

Presentation Layers

In accordance with one preferred embodiment, the presentation devices communicate via any number of communication links with at least one application server associated with the respective presentation layer (the application servers are described below in connection with the different presentation layers). As used in this description, a “communication link” may refer to the medium or channel of communication, in addition to the protocol used to carry out communication over the link. In general, a communication link may include, but is not limited to, a telephone line, a modem connection, an Internet connection, an Integrated Services Digital Network (ISDN) connection, an Asynchronous Transfer Mode (ATM) connection, a frame relay connection, an Ethernet connection, a coaxial connection, a fiber optic connection, satellite connections (e.g., Digital Satellite Services), wireless connections, radio frequency (RF) connections, electromagnetic links, two-way paging connections, and combinations thereof.

As described in more detail below, communication links may be suitably configured in accordance with the particular communication technologies and/or data transmission protocols associated with the given presentation device. For example, a communication link may utilize (without limitation) broadband data transmission techniques, the TCP/IP suite of protocols, WAP, WML, XML, HTML, or a combination thereof. Communication links may be established for continuous communication and data updating or for intermittent communication, depending upon the infrastructure. Application servers may be realized as a single hardware component or as a plurality of interconnected components (which may or may not be distributed over different physical locations).

Application servers generally function to translate “generic” data received from map servers 504 into formats suitable for use in conjunction with the native protocols associated with the respective presentation devices. In this respect, system 500 may include an application server for each different presentation device. Thus, one application server may be configured for compatibility with a wireless telephone, a second application server may be configured for compatibility with a settop box, a third application server may be configured for compatibility with a PDA , a fourth application server may be configured for compatibility with a personal computer, and so on. In the context of a practical deployment, a given application server may service a plurality of end users. For example, one application server may service a plurality of satellite television set-top presentation devices for a group of different subscribers, while another application server may service a plurality of cellular telephone presentation devices for a different group of subscribers. For a given system 500, the application servers can be realized by one hardware component or by a plurality of hardware components distributed in different physical locations.

The application servers are preferably configured to communicate with map servers 504 using the TCP/IP suite of protocols. In alternate embodiments, system 500 may utilize any data transmission scheme or protocol between the presentation layers and map servers 504. In one practical implementation, each service provider or system operator maintains (or is associated with) a distinct map server or a distinct collection of distributed map servers. In the preferred embodiment, map servers 504 are physically placed in a location remote from the presentation devices. Although not a requirement of the present invention, map servers 504 and one or more of the application servers may be physically located in the same facility. Indeed, map servers 504 and one or more of the application servers may reside on the same hardware device or on a single computer network. However, for practical reasons (and for purposes of scalability) multiple server devices are preferred.

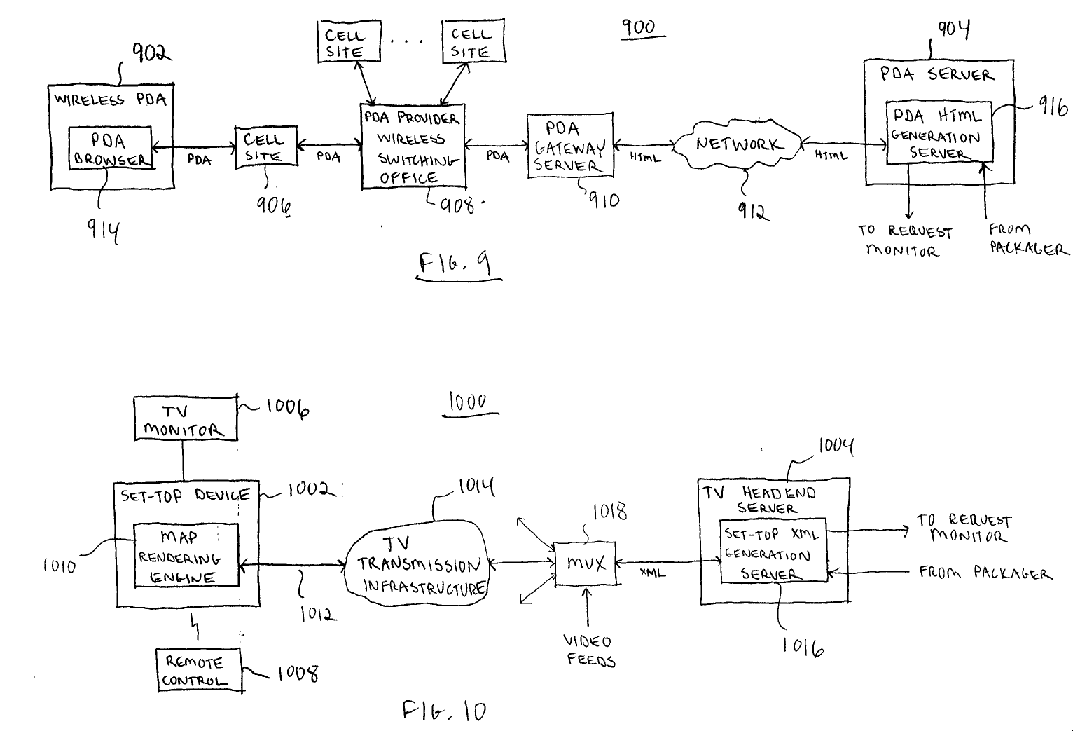

FIG. 7 is a schematic representation of an exemplary personal computer (or web) presentation layer 700. Web presentation layer 700 may be implemented in connection with any computing device, e.g., a desktop personal computer, a laptop computer, a networked computer, a server computer, a hand-held computer, or in connection with any appliance or device capable of supporting a web browser application (such as a video game console, home appliances, or electronic entertainment systems). In a practical application, any number of suitable personal computers are commercially available from manufacturers such as IBM, DELL, APPLE, COMPAQ, HEWLETT-PACKARD, and various suppliers of “generic” personal computers. The basic configuration and operation of these computing devices and other web browser compliant devices are generally well known to those skilled in the art. Accordingly, for the sake of brevity, the detailed operation of these web browser compliant systems and devices will not be described herein.

In the context of this example, web presentation layer 700 includes a personal computer 702, which includes a web browser application 702. Personal computer also includes a suitable operating system (not shown) that controls the general operating functions of personal computer 702, including functions related to the manner in which personal computer 702 renders graphical features on its display element. In a practical embodiment, the operating system may be configured in accordance with any commercially available format, e.g., WINDOWS, LINUX, MAC OS, or the like. Web browser 704 may be configured in a conventional manner to allow the user to view web pages transmitted via HTML, TCP/IP, and other known techniques and protocols utilized in the context of Internet communications. A number of commercially available web browser applications may be suitable for use in connection with personal computer 702, e.g., INTERNET EXPLORER or NETSCAPE. Internet service providers, such as AMERICA ONLINE, may provide suitable web browser applications to subscribers; such web browser applications are also compatible for use in the context of the present invention. Notably, personal computer 702 need not be modified to support the navigation display features of the present invention, i.e., a wholly conventional personal computer 702 may be used in the context of the present invention.

Any number of end user computer systems, such as personal computer 702 can be operatively coupled to network 708. In addition, a number of end user personal computers may be interconnected in the form of another network, e.g., a LAN. As used herein, a “computer system” is a product including circuitry capable of processing data. A computer system may include, but is not limited to, general purpose computer systems (e.g., servers, laptops, desktops, hand-held devices, and PDAs), personal computers, hard copy equipment (e.g., printers, plotters, and facsimile machines), banking equipment such as an automated teller machine, and the like. A computer system may operate in conjunction with any number of application programs, driver programs, utility programs, files, graphics, documents, data, and the like, either singly or in any combination.

In operation, personal computer 702 is capable of communicating with a web server 706 via a network 708 (such as the Internet). Network 708 (or a suitable remote site) allows map servers 504 and/or other elements of the system to provide information and services to personal computer 702 using software that is maintained by the system administrators (in contrast to local applications). The various system databases are used to store relevant data such as map data, user preferences, programming information, and the like. Personal computer 702 may be connected over a corresponding communication link 709 (such as a local carrier exchange) to a respective Internet service provider (not shown), through which access to network 708 is made. By inputting the URL address of the target website with which the user desires to interact (such as a website associated with a navigation display interface according to the present invention), the user may be connected to various interconnected web servers, Internet service providers, or the like. In an alternate embodiment, each user may be connected over a corresponding communication link to a service center maintained by the navigation system provider, which provides Internet access and service to the end user computer systems.

In the preferred embodiment, web server 706 communicates with a personal computer application server 710. Personal computer 702 suitably responds to navigation map display data that originates at server 710. In a practical application, server 710 may be deployed and maintained by a content provider, an Internet service provider, a third party application hosting service, or any entity having connectivity to the Internet and having appropriate processing capabilities.

Server 710 preferably includes an HTML generation server 712, which is suitably configured to receive generically formatted map data from map severs 504 (e.g., from packager 610) and to translate such generically formatted data into a format compatible with web server 706, e.g., HTML. End user requests may also be sent from HTML generation server 712 to map servers 504 (e.g., to request monitor 602). Web server 706 may be configured in a conventional manner to provide web navigation capabilities in connection with the Internet. In a practical embodiment, web server 706 may employ commercially available applications such as APACHE, MICROSOFT IIS, NETSCAPE, or the like. Web server 706 may operate to manage, process, and deliver HTML documents (such as web pages and formatted navigation map data) in response to requests from personal computer 702. In a practical embodiment, web server 706 and/or server 710 are maintained by a system administrator or service provider to provide one or more websites associated with the functionality of the navigation display system.

In operation, server 710 communicates with map servers 504 using TCP/IP. Thereafter, the navigation map data from map servers 504 is transformed into suitable HTML documents for transmission over the Internet from server 710 to personal computer 702. Eventually, personal computer 702, in conjunction with web browser 704 and/or the personal computer operating system, processes the HTML navigation map data in a suitable manner for displaying at the personal computer monitor or display element. As another processing example, server 710 can request a portion of a map from the map system. In response, server 710 may receive a graphics representation of the entire map surface at a given zoom resolution (an image) and a list of the map items that should be displayed in the requested portion of the map. The server 710 can then clip the image to match the displayable window and render the individual map items that will be visible to the user. Next, server 710 creates the HTML data to display the image and transmits the HTML and image files to web browser 704 for eventual display to the end user.

In the context of a practical application of the present invention, end user computer systems may be utilized to locate and play Internet-based streaming media files associated with any number of content providers. The end users can access a web site associated with the web presentation layer 700 and view one or more navigation maps configured to display available media files that can be downloaded for playback by the end user computer systems. In alternate embodiments, web presentation layer 700 allows the end users to access, monitor, and/or control any network-accessible documents, files, equipment, or appliances.

FIG. 8 is a schematic representation of an exemplary cellular telephone presentation layer 800. The cellular telephone embodiment described herein assumes that the cellular telephone is enabled with a WAP (or any suitable protocol utilized by wireless devices) web browser and that the cellular telephone is configured to communicate via WAP over TCP/IP, tiny HTML (or any equivalent wireless data transmission protocol). In a typical cellular telephone environment, cellular telephone presentation layer 800 preferably includes a cellular telephone 802 that communicates with a suitable cellular phone application server 804.

Cellular telephone 802 is preferably configured in accordance with conventional Internet-enabled wireless phones. In this respect, cellular telephone 802 may include a cell phone WAP browser application 806 and a phone operating system (not shown). The phone operating system is suitably configured to control the general operating functions of cellular telephone 802 in a conventional manner. Such functions typically include the basic telephone features, address book features, text messaging capabilities, alarm features, calendaring, email, and the like. In a practical embodiment, the operating system may be provided by the particular manufacturer of cellular telephone 802. Cell phone browser 806 is configured in a conventional manner to allow the user to view web pages transmitted via WAP. Notably, cellular telephone 802 need not be modified to support the navigation display features of the present invention, i.e., a wholly conventional web-enabled cellular telephone may be used in the context of the present invention.

In operation, cell phone 802 communicates with a cell site 808 associated with the wireless communication network (as shown in FIG. 8, the wireless network may include any number of cell sites). As described above, cell phone 802 preferably communicates data over the wireless network using WAP or any suitable communication protocol. The cell site 808 communicates with a cellular service provider switching office 810 in a conventional manner. In turn, the switching office 810 communicates with a communication network 812 capable of transmitting data (e.g., a wide area network or the Internet). In this manner, network 812 allows the navigation service provider to provide information and services to the end user cell phone 802 using server-based software applications.

Cellular telephone 802 responds to inputs received from server 804, where such inputs convey navigation map display data. A communication path between cellular telephone 802 and server 804 is established using wireless communication techniques that facilitate WAP transmissions. In a practical application, server 804 may be deployed and maintained by the cellular service provider, a content provider, or a hosting entity. In practice, server 804 is not considered to be a part of the wireless telephone network.

Server 804 preferably includes a wireless markup language (WML) generation server 814, which is suitably configured to receive generically formatted map data from map servers 504 (e.g., from packager 610) and to translate such generically formatted data into the native format or protocol associated with cellular telephone 802, e.g., WML. End user requests may also be sent from WML generation server 814 to map servers 504 (e.g., to request monitor 602). In a practical embodiment, server 804 communicates with switching office 810 using WML over TCP/IP. Switching office 810 obtains the WML information from server 804 and places corresponding WAP information onto the wireless network using known techniques. Eventually, cellular telephone 802, in conjunction with cell phone WAP browser 806 and/or the phone operating system, processes the WAP-encoded map data in a suitable manner for displaying at the cellular telephone display element. In this respect, server 804 is capable of communicating the navigation map information to the cellular telephone 802.

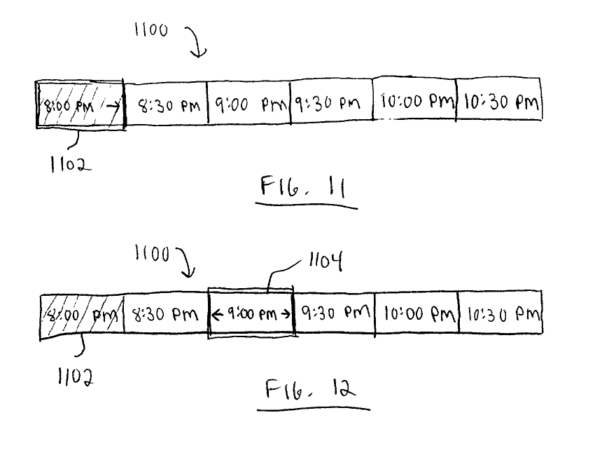

FIG. 9 is a schematic representation of an exemplary PDA presentation layer 900. For purposes of this example, PDA presentation layer 900 assumes that the presentation device is a PDA 902 capable of establishing wireless connections to the Internet. A number of commercially available PDAs can be utilized in this context, including, without limitation, the Pahn VII from PALM, INC., the iPAQ Pocket PC H3600 Series from COMPAQ, and other PDAs compatible with wireless modem technologies. In the context of this example, PDA presentation layer 900 includes PDA 902, which is configured to communicate with a PDA application server 904 via a wireless network (which includes a cell site 906 and a PDA provider wireless switching office 908), a PDA gateway server 910, and a network 912 such as the Internet. PDA 902, the wireless network, PDA gateway server 910, and the manner in which PDA 902 communicates in a wireless mode with PDA gateway server 910 are known to those skilled in the art. Accordingly, these aspects of PDA presentation layer 900 will not be described in detail herein.

In accordance with conventional designs, PDA 902 includes a PDA browser application 914 and a PDA operating system (not shown). The operating system is suitably configured to control the general operating functions of PDA 902, including functions related to the manner in which PDA 902 renders graphical features on its display element. In a practical embodiment, the PDA operating system may be configured in accordance with any commercially available PDA format, e.g., PALM OS or WINDOWS CE. PDA browser 914 is configured in a conventional manner to allow the user to view web pages transmitted via a suitable wireless PDA protocol such as the protocol utilized by devices manufactured by PALM, INC. Notably, PDA 902 need not be modified to support the navigation display features of the present invention, i.e., a wholly conventional wireless PDA 902 may be used in the context of the present invention.

In a wireless operation mode, PDA 902 communicates with cell site 906 (which, as depicted in FIG. 9, may be one of several cell sites associated with the wireless network). The cell site 906 communicates with PDA provider wireless switching office 908 via the wireless PDA protocol. In turn, switching office 908 communicates with PDA gateway server 910 using the wireless PDA protocol. The communication between switching office 908 and PDA gateway server 910 may be carried over any suitable communication link, e.g., wireless or otherwise. The PDA gateway server 910 is suitably configured to communicate with server 904 via network 912. In this manner, the navigation service provider can provide information and services to the end user PDA 902 using server-based software applications.

PDA gateway server 910 enables PDA 902 to display web pages, documents, and graphics that may be otherwise incompatible with the capabilities of the PDA display element. In a practical environment, PDA gateway server 910 can be maintained by a third party provider. PDA gateway server 910 is configured to receive requests from PDA 902 and to communicate the requests to appropriate web servers via the Internet. Generally, PDA gateway server 910 receives conventional HTML documents via the Internet and transforms the documents into a format suitable for display at PDA 902. For example, PDA gateway server 910 may receive a web page document and remove or condense the graphical elements and active elements from the document, thus leaving text and simple graphics. PDA gateway server 910 is also configured to repackage the HTML documents for transmission to PDA 902 via the PDA wireless protocol (as opposed to TCP/IP or WAP). For example, PDA gateway server 910 may compress portions of the HTML to increase the transmission speed over wireless network.

In accordance with the practical embodiment shown in FIG. 9, server 904 includes a PDA HTML generation server 916, which is configured to receive the generically formatted map data from map servers 504 (e.g., from packager 610) and to reformat such map data into a format that will ultimately be compatible with PDA 902. End user requests may also be sent from generation server 916 to map servers 504 (e.g., to request monitor 602). In this manner, server 904 need not be specially configured to communicate directly with PDA 902. Rather, PDA presentation layer 900 is preferably configured to leverage existing PDA gateway servers, which are maintained by third party providers.

In operation, PDA 902 responds to navigation map display data that originates at server 904. As described previously, the map data is originally transmitted in the form of HTML using TCP/IP from server 904. In a practical application, server 904 may be deployed and maintained by a content provider, a wireless service provider, or a third party application hosting service.

The application database (not shown in FIG. 9) for the PDA implementation may communicate with entities other than the map system. For example, one practical application may employ an electronic programming guide for television programs, where the guide is accessible from a set-top box, a web browser, and PDA 902. The map system can be shared by these multiple presentation layers and the application database can be the same database utilized by the set-top presentation layer. In other words, the PDA presentation layer 900 may share an application database with one or more other presentation layers.

In operation, server 904 communicates with map servers 504 using TCP/IP. Thereafter, the navigation map data from map servers 504 is transformed into suitable HTML documents (e.g., a web page) for transmission over the Internet from server 904 to PDA gateway server 910. As described above, PDA gateway server 910 processes the HTML documents that contain the map data and transmit the repackaged data to PDA 902 via the wireless network. Eventually, PDA 902, in conjunction with PDA browser 914 and/or the PDA operating system, processes the repackaged navigation map data in a suitable manner for displaying at the PDA display element.

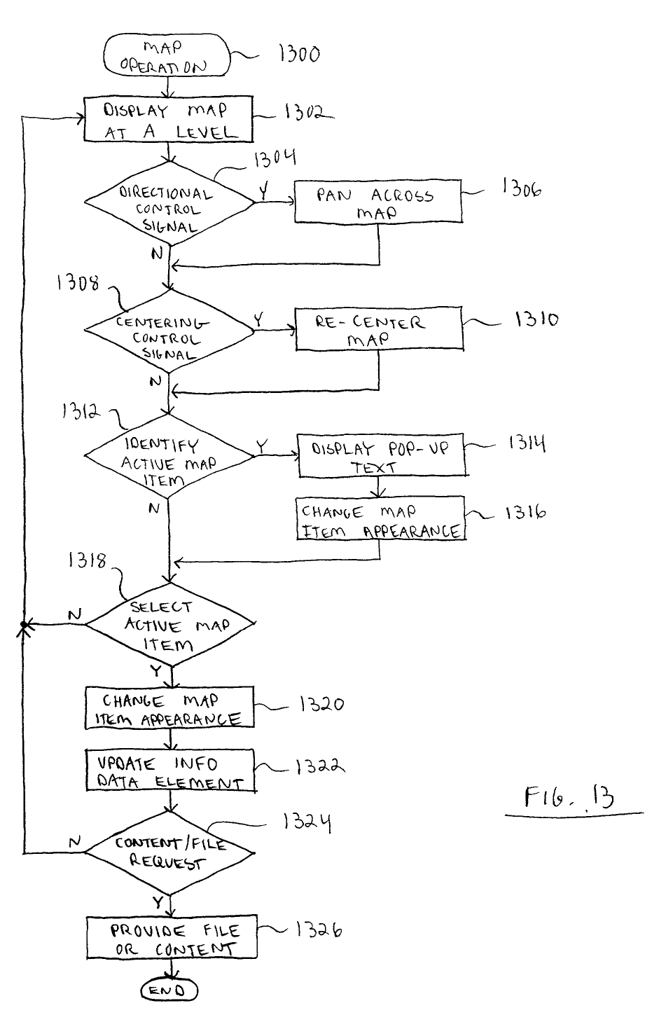

FIG. 10 is a schematic representation of an exemplary set-top presentation layer 1000. In the context of a cable television or satellite television system, set-top presentation layer 1000 preferably includes a set-top device 1002 that communicates with a television headend server 1004. In this respect, headend server 1004 functions as an application server. Set-top device 1002 may be a separate converter box or an integral component of a television set, a VCR, a decoder element, or the like. In a typical installation, set-top device 1002 is located at the end user's premises. Accordingly, set-top device 1002 may function in cooperation with a television display screen or monitor 1006 and a control device, e.g., a remote control 1008.

Set-top device 1002 may include a rendering engine 1010, an operating system (not shown), and any number of other software applications. The operating system is suitably configured to control the general operating functions of set-top device 1002 in a conventional manner. In a practical embodiment, the operating system may be configured in accordance with any of the following known systems: WINDOWS CE, POWERTV, or VRTX. In many respects, set-top device 1002 may function like a general purpose computer system to control the various television functions and to perform any number of additional operations. Accordingly, additional software applications may be related to email applications, web browser applications, program recording applications, television control applications, games, and the like.

Rendering engine 1010 is an optional element of set-top presentation layer 1000. However, the preferred embodiment utilizes rendering engine 1010 to optimize the rendering of the navigation maps. Rendering engine 1010 facilitates quicker operation because some of the graphics generation and manipulation is performed at the local layer rather than by the servers. The rendering engine 1010 may be suitably configured to optimize the graphics according to the particular capabilities of the settop device 1002 and/or according to the specifications of the television display element 1006. In this regard, the rendering engine 1010 might request a 3-D mesh representation of the navigation map and then use a 3-D graphics processor located at the presentation device to render the map in a 3-D format. In addition, rendering engine 1010 may be configured to add finctionality to the presentation layer 1000. For example, local rendering may allow presentation layer 1000 to cache the appearance of the entire map locally, thus avoiding network latency associated with the transfer of a large number of images each time the user scrolls the map. This feature also allows the presentation layer 1000 to quickly update only the navigation map portion of the display without having to devote resources to the regeneration of other displayed elements. Although rendering engine is described herein in connection with set-top presentation layer 1000, the present invention may implement equivalent rendering engine functionality in any presentation layer associated with a given display device.

In the absence of rendering engine 1010, set-top device 1002 will simply respond to inputs received from headend server 1004, where such inputs convey navigation map display data. In this regard, headend server 1004 can create HTML or XML maps that are eventually displayed in connection with a web browser or other application resident at the set-top device 1002. Communication links 1012 associated with set-top device 1002 and the television transmission infrastructure 1014 may be conventional broadband cable connections (carried by coaxial cables or fiber optic lines) or satellite links. In a practical application, headend server 1004 may be deployed and maintained by the programming service provider. For example, headend server 1004 may be located with the headend equipment maintained by a cable television service provider, where the headend equipment may service any number of end users.

Headend server 1004 preferably includes a set-top generation server 1016 and a server operating system (not shown). The operating system, which may be configured in accordance with known techniques, carries out the general operating tasks associated with headend server 1004. The operating system preferably runs conventional server operating system programs, e.g., WINDOWS NT, LINUX, UNIX, or the like. In this respect, the server operating system is capable of communicating with the operating system used by set-top device 1002.

Set-top generation server 1016 is suitably configured to receive generically formatted map data from map servers 504 (e.g., from packager 610) and to translate such generically formatted data into a native format or protocol associated with settop device 1002, e.g., a cable transmission protocol utilized by the cable service provider. End user requests may also be sent from generation server 1016 to map servers 504 (e.g., to request monitor 602). The server operating system, in conjunction with the set-top operating system and/or rendering engine 1010, can process the map data in a suitable manner for displaying at television monitor 1006. If set-top device 1010 utilizes rendering engine 1010, then generation server 1016 may translate the generic map data into a more compact format, e.g., XML, that can be read by the rendering engine 1010 to generate the map. If no rendering engine is used, then generation server 1016 may translate the generic map data into an HTML representation that can be directly viewed in connection with an application (such as a web browser) on the set-top device 1002.

The XML or HTML data generated by generation server 1016 may be fed to a multiplexer 1018. Multiplexer 1018 may be configured in accordance with known techniques to mix the map data with a number of video feeds. The mixed signals are then transmitted to the respective presentation device. For example, a cable television implementation may utilize a cable multiplexer that mixes the map data with the video signals and transmits the mixed signal via a coaxial cable. In this manner, the XML or HTML map data is ultimately encapsulated into data transmitted according to the television service provider communication protocol.

Miscellaneous Map System Features

Various embodiments of navigation interface display system 500 may employ additional functionality and features depending upon the particular application, user preferences, and/or the preferences of the service entity responsible for deploying the display system 500. The various hardware and software components described herein can be suitably configured to carry out these functions in addition to the general functions related to the generation and display of the navigation maps. The following map system features are described in detail below: (1) filtering of map items; (2) user data monitoring; (3) dynamic linking between the presentation layer and the map system; (4) generic map representations; (5) tile-based map construction; and (6) the display of “time-shifted” navigation maps.

Display system 500 is preferably configured to allow the end user application (e.g., the web browser or operating system) to designate a subset of map items to display for any given processing of a map generation request. This feature enables applications to filter map items during the map generation process. During the filtering process, any property or characteristic of a map item can be changed to reflect the filtered status, e.g., the visibility, location on the map, name, icon appearance, hierarchical ordering, or the like. The properties or characteristics that form the filtering criteria may be related to: the popularity of the map item; the current online or offline status associated with the map item; the associated data rate for the transfer of content; language restrictions related to the content; whether the map item is marked as a user favorite; the maturity rating associated with the content; whether the map item represents free programming or pay per view programming; the programming times associated with the content; or whether the associated content is available as part of the user's subscription package. In accordance with one embodiment, each end user's view of the map items can be unique because the filtering procedure can be individually carried out for each user. Consequently, the filtering feature can be used in a supervisory context to remove or hide map items based on any number of criteria, e.g., programming for mature audiences may be screened from children.

In an alternate embodiment, the filtering feature may be cumulative or collaborative in nature such that map items are filtered according to feedback associated with a plurality of end users rather than according to individual preferences or use habits. For example, the prioritization of display of map items may be dictated by the aggregate preferences of a number of end users or by a statistical popularity rating based on a number of end users. In such an embodiment, a map item that is generally popular among a large number of end users may be dynamically assigned a high level of visibility on all of the respective navigation maps.

The presentation layer 502 and/or the map servers 504 can perform the filtering procedure. For example, in response to a map request from a presentation layer 502, the map servers 504 may retrieve the map images, generic map data, and map items associated with the requested map. The map servers 504 may then apply any global filtering (i.e., filtering that is automatically applied to a number of users) and any user-specified filtering to the requested map. Such filtering may reduce the number of map items or otherwise modify the generic map data retrieved by the map system. The map servers 504 subsequently transmit the filtered generic map data to the presentation layer 502. At that time, the presentation layer 502 may apply any local filtering that is specific to the particular presentation layer, presentation device, or user preferences. Eventually, the presentation layer 502 represents the filtered map data as required for rendering on the given presentation device.

The server-based deployment of navigation interface display system 500 enables the monitoring, collection, and processing of information related to the use of the navigation maps. For example, the display system servers can be suitably configured to maintain data related to the popularity of specific map items, the popularity of different programming genres, demographic information, times of use, and other relevant data. This information can then be summarized using conventional or proprietary data mining techniques. The display system 500 may provide remote access to the collected data by authorized parties.

As described above, the presentation layer 502 preferably establishes communication with the map servers 504 via a URL (or other suitable identifier) that identifies a particular navigation map maintained by map servers 504, the map display area, the user identification, and any other information desired by the presentation layer 502. In accordance with a preferred aspect of the present invention, the presentation layer 502 is capable of assigning any number of additional “map identifiers” to the given URL. A map identifier, which serves as a link to the presentation layer 502, may then be embedded into the data or code of another application. This feature gives the administrator or provider of the navigation interface display system 500 the flexibility to assign another map URL to a given map identifier. In other words, a given URL can be made to point to a completely different map if the system administrator decides to change the current map. The dynamic linking aspect of the present invention provides a powerful mechanism to easily change navigation maps at the map system without having to update the application code and data resident at the presentation layers 502.

As mentioned above, map servers 504 are preferably configured to process, manipulate, and produce generic representations of the various navigation maps. Thus, the map data generated by the map servers 504 is formatted in accordance with one or more common protocols, regardless of the manner in which the navigation map will ultimately be rendered, and the presentation layers 502 are responsible for “converting” the generic map data for use by the particular presentation device. In other words, from the perspective of the server-based map system, all navigation maps share the same generic formatting characteristics and map servers 504 need only be aware of the general map characteristics associated with the generation of a map request, e.g., the number of map items, the relative positioning of map items on the display screen, the hierarchical prioritization of active map item display, and the like. In a practical embodiment, a navigation map can be fully described by a set of data comprising XML documents and images that are manipulated by the map system to make the map unique.

With respect to the generic map representation, navigation interface display system 500, and map servers 504 in particular, preferably employs a generic display coordinate system to accommodate different display elements having potentially different resolution characteristics. The generic coordinate system may be utilized to represent map items (and other graphical features) locations in an abstract “absolute coordinate” grid, where the actual visible location of the map items can vary depending upon the presentation layer 502 and/or the presentation device display element. For example, the map system may designate a navigation map to be 10,000 ×10,000 absolute display units. On a relatively low resolution display element having a 200 pixel×200 pixel display (such as a PDA display element), the corresponding conversion would be 50 absolute display units per pixel. On a relatively high resolution display element having an 800 pixel×800 pixel display (such as a personal computer monitor), the corresponding conversion would only be 12.5 absolute display units per pixel. The conversion from absolute display units to pixels (which is performed by the presentation layer) can dynamically change according to the particular magnification level that is currently displayed.

The map system may also implement a generic representation scheme for the appearance of icons used for the rendering of the map items (or other graphical features displayed on the navigation maps). In accordance with one preferred embodiment, a map item has a virtual image identifier associated therewith. The virtual image identifier defines the appearance of its iconic or graphical representation. For example, a virtual image identifier may simply designate that the map item icon resembles a telephone. Different presentation layers may respond to the virtual image identifier in unique ways to thereby render the telephone icon in an appropriate manner depending upon the presentation device. For example, on a low resolution display element, map item icons may be rendered as an 8 pixel×8 pixel gray-scale graphic. In contrast, a web browser may render the same map item icon as a larger 16 pixel=16 pixel color graphic. In a set-top box embodiment, the same map item icon may be rendered as a fully textured three dimensional object.

In accordance with one practical embodiment, map servers 504 represent the navigation maps using a tile-based technique. Using this technique, a map is divided into a grid of graphical tiles, e.g., a grid of 50=50 tiles. The map system need only store a unique tile identifier for each tile location. In view of the different zoom levels associated with a single map, there are a plurality of tiles corresponding to each zoom level. For example, if the map can be displayed at 5,000 pixels=5,000 pixels, 10,000 pixels=10,000 pixels, and 20,000 pixels=20,000 pixels, the map will have three tiles (one for each zoom level) associated with a given grid position: a 10 pixel =10 pixel tile; a 20 pixel =20 pixel tile; and a 40 pixel=40 pixel tile. The tile-based technique leverages redundancy in a navigation map display such that the map system need not waste memory and processing resources when rendering tiles that are substantially identical in appearance. Rather, the map system need only store the appearance characteristics of one tile and the tile identifier of all tiles of similar or identical appearance. In practice, the use of such tile-based rendering allows the map system to operate at a higher speed relative to a system that does not use the tilebased technique.

A navigation map display may include an active element that allows the end user to shift the programming time associated with the given map. For example, as described above in connection with FIGS. 1-4, an end user can conveniently determine what programs or files are currently being broadcast. In addition, a navigation map may include an information element 106 (see FIG. 1) that contains current and future programming information for a selected station or channel. However, many end users also like to see future programming information for more than one station or channel.

FIG. 11 is a schematic representation of an example time-shifting element 1100 that may be rendered in connection with a navigation map, and FIG. 12 depicts element 1100 in a modified state. Time-shifting element 1100 may display any number of specific program times before and/or after the current time slot. For example, time-shifting element 1100 includes six half-hour time slots; the specific time slots may change as time progresses. Time-shifting element 1100 preferably highlights, shades, colors, or otherwise indicates the time slot corresponding to the actual time. A current time slot 1102 (8:00 PM) is shaded in FIGS. 11 and 12. Time-shifting element 1100 is also rendered in a manner that indicates the current state of the displayed navigation map. For example, in FIG. 11, the current time slot 1102 also corresponds to the currently displayed map. However, in FIG. 12, the 9:00 PM time slot 1104 corresponds to the currently displayed map. Notably, time slot 1104 is not shaded or colored because it does not indicate the present time period.

In the preferred embodiment, the navigation map system defaults to display the navigation map corresponding to the actual present time slot. However, the end user may change the navigation map time perspective by entering an appropriate command or request, e.g., by clicking on a different time slot on time-shifting element 1100 or by engaging a suitable key on a keypad, such as a directional key. Time-shifting element 1100 may include directional arrows that indicate whether the navigation map can be moved forward or backward in time. For example, FIG. 11 shows a forward arrow displayed in connection with the current 8:00 PM time slot 1102 and FIG. 12 shows forward and reverse arrows displayed in connection with the future 9:00 PM time slot 1104.

In response to a time-shifting request from the presentation device, the time-shifting element 1100 will change to reflect the new time slot. In addition, the displayed navigation map will be modified to reflect the programming corresponding to the new time slot. For example, the appearance of the map items, the content of map item labels, the content of pop-up text boxes, the content of any preview windows, the station information, and/or the particular program information may change according to the programming data for the selected time slot. In this manner, the end user can continue to move forward (or backward) in time to view the program listings for different stations and channels at any number of time slots.

Operation Of An Example Display System

The operation of a sample navigation interface display system according to the present invention will now be described with reference to the display screens depicted in FIGS. 1-3. It should be appreciated that the screens shown in FIGS. 1-3 and the following description of various user manipulations of the navigation maps are merely illustrative of one specific implementation of the present invention. Indeed, a practical embodiment can include any number of additional or alternative processing tasks and/or any number of different display navigation features.

FIG. 13 is a flow diagram of an exemplary map operation process 1300 that may be performed in the context of the present invention. Although process 1300 may be carried out by navigation interface display system 500 using any of the presentation layers 502 described herein, the display screens depicted in FIGS. 1-3 are suitable for use with set-top presentation layer 1000 (see FIG. 10) and personal computer presentation layer 700 (see FIG. 7), both of which are associated with a suitably high display resolution.

For the sake of simplicity, process 1300 assumes that the current navigation map is being maintained at a constant magnification or zoom level. In other words, process 1300 does not contemplate changes in zoom (such changes are described below in connection with FIGS. 15 and 16). Accordingly, the features associated with process 1300 may be equivalently applied to any magnification level of a navigation map.

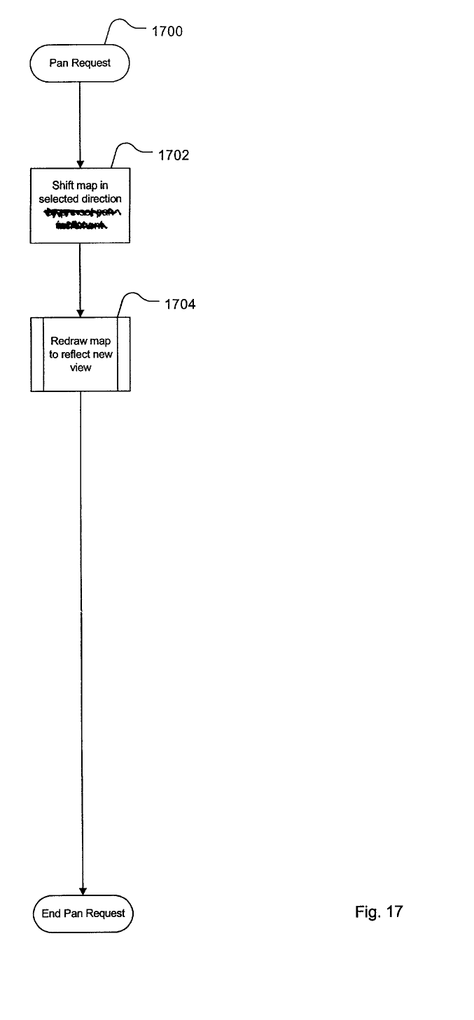

Map operation process 1300 begins by displaying a navigation map at a given magnification level (task 1302). For example, navigation map 208 (see FIG. 2) is associated with an intermediate magnification level, i.e., at least one higher level and at least one lower level remain. In connection with a query task 1304, if the respective presentation layer receives a directional control signal (which will usually be initiated by the end user of the presentation device), then a task 1306 is performed to pan across the navigation map in response to the control signal. The processing of a pan request is also described below in connection with FIG. 17. In a practical embodiment, the presentation layer and/or the server-based map system causes the panning action to be rendered. As described above, the display system 500 may be suitably configured to provide any number of discrete panning directions or to provide a substantially fluid and continuous panning movement.

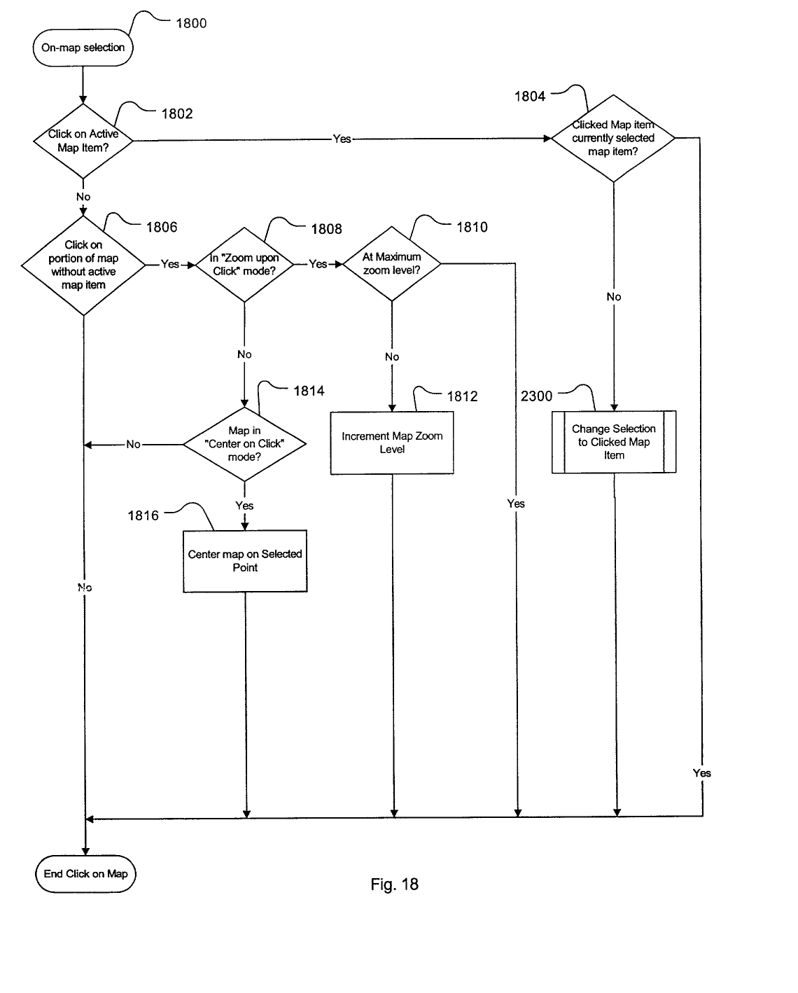

In connection with a query task 1308, if the respective presentation layer receives a centering control signal (which will usually be initiated by the end user of the presentation device or by the map system), then a task 1310 is preferably performed to re-center a visible portion of the navigation map in response to the centering control signal. In the preferred practical embodiment, the re-centering feature is only applicable to re-center about visible portions of the currently displayed navigation map. For example, if navigation map 328 (see FIG. 3) is the currently displayed map, then the end user will not be permitted to re-center the map about any of the graphical features that are outside the “boundary” of map 328. A centering control signal can be initiated by the end user by positioning a pointing device cursor over the portion of the map that is to serve as the approximate center point. As with the panning motion, the centering motion may be initiated by the presentation layer and/or by the map system. In conjunction with such a centering command, display system 500 may automatically increase the level of magnification of the navigation map, thus progressing to a re-centered and magnified version of the previous map. For example, navigation map 208 depicts a re-centered and magnified version of navigation map 108, and navigation map 328 depicts a magnified version of navigation map 108, re-centered about graphical feature 122. The processing of a centering control signal is also described below in connection with FIG. 18.

If the presentation layer detects that a particular active map item is identified (query task 1312), then a task 1314 may be performed. Query task 1312 preferably determines whether the end user has positioned a pointing device cursor over or proximate to an active map item. If so, then task 1314 causes a pop-up text box to appear on or near the identified active map item. As described above, and as depicted in FIG. 1 in conjunction with active map item 126, the pop-up text box preferably contains information related to the content (and/or source of the content) linked to that active map item. In addition to task 1314, a task 1316 may be performed to change the appearance of the identified active map item, thus highlighting that map item. In the example embodiment, task 1316 causes the identified active map item to change from a first color to a second color. Tasks 1314 and 1316 are preferably performed by the respective presentation layer and/or by the map servers 504.

As described above, the active map items are configured such that the end user can select them using a suitable on-screen pointing device (e.g., a mouse, a touchpad, a trackball, or a touch screen), a remote control device, or the like. With respect to query task 1318, if the respective presentation layer determines that an active map item has not been selected, then map operation process 1300 may be reentered at task 1302 (in such a mode, the end user may be merely navigating over the various active map items to view current programming status via the pop-up text boxes). On the other hand, if query task 1318 determines that an active map item has been selected, then a task 1320 may be prompted. Task 1320, which is preferably performed by the presentation layer and/or by the map servers 504, changes the appearance of the selected active map item. The altered appearance may be desirable to provide a visual cue that an active map item has been selected. For example, upon selection of an active map item, the example embodiment displays flashing red arcs 202 proximate the selected active map item (see FIG. 2).

In addition to task 1320, the presentation layer and/or the map system may be configured to update the information element 106 (see FIG. 1) in response to the selected active map item (task 1322). As described above, this updating preferably includes programming information such as the name of the program, the program start time, the network name, the channel or station number, or the like. In the preferred embodiment, the information contained in information element 106 remains intact until a different active map item is selected (query task 1318) or until the programming information for the same active map item is updated (which may occur automatically as time progresses). In addition, any of tasks 1306, 1310, 1314, and 1316 may be continuously performed with an active map item selected and with programming information contained in information element 106.

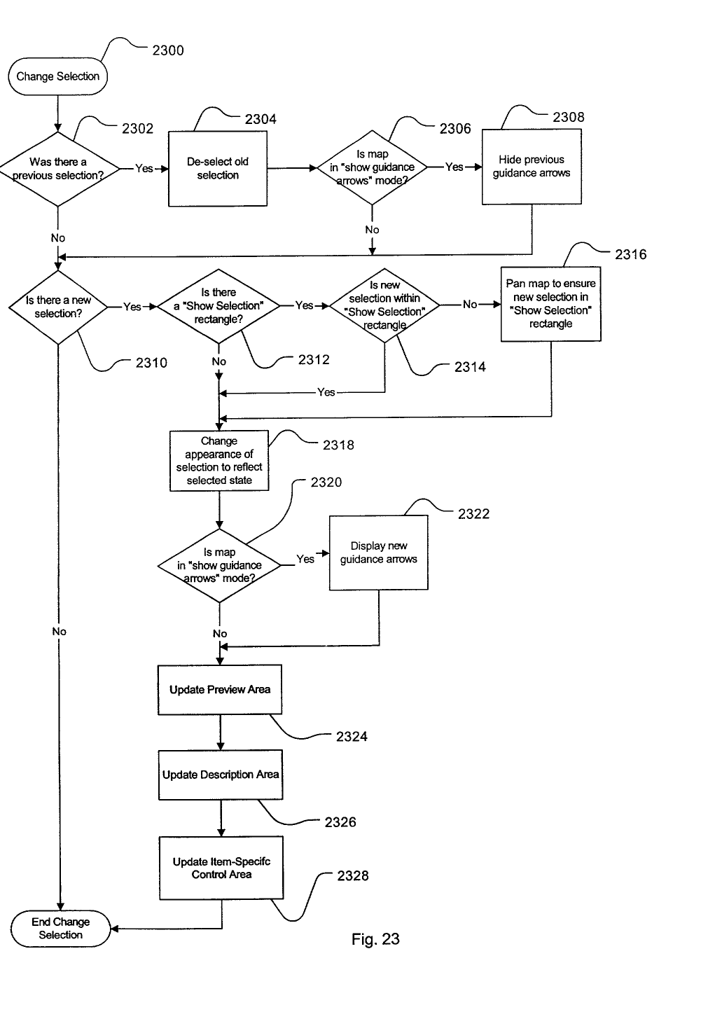

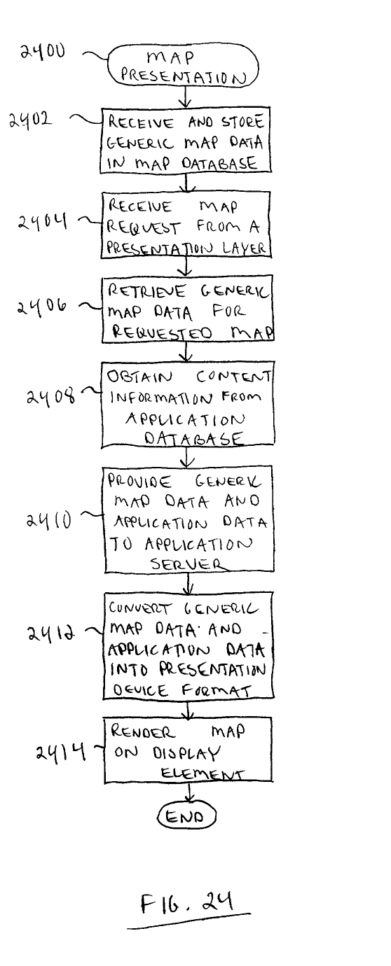

The processing of a selected active map item is described in more detail below in connection with FIGS. 18 and 23.

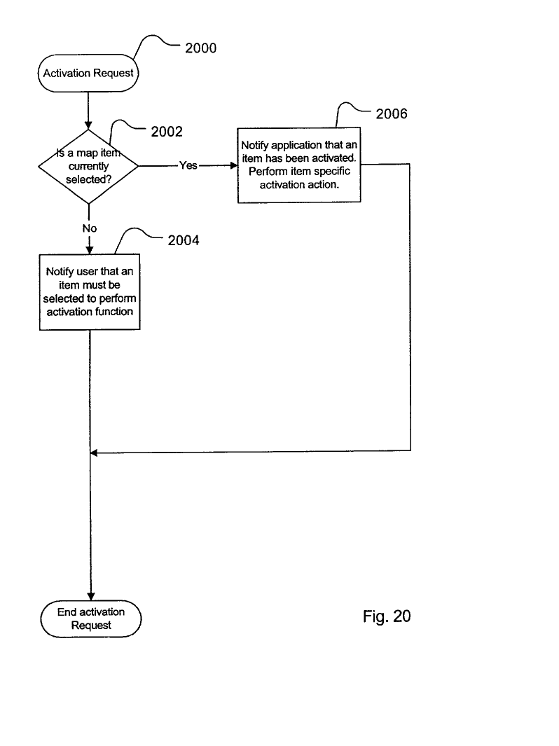

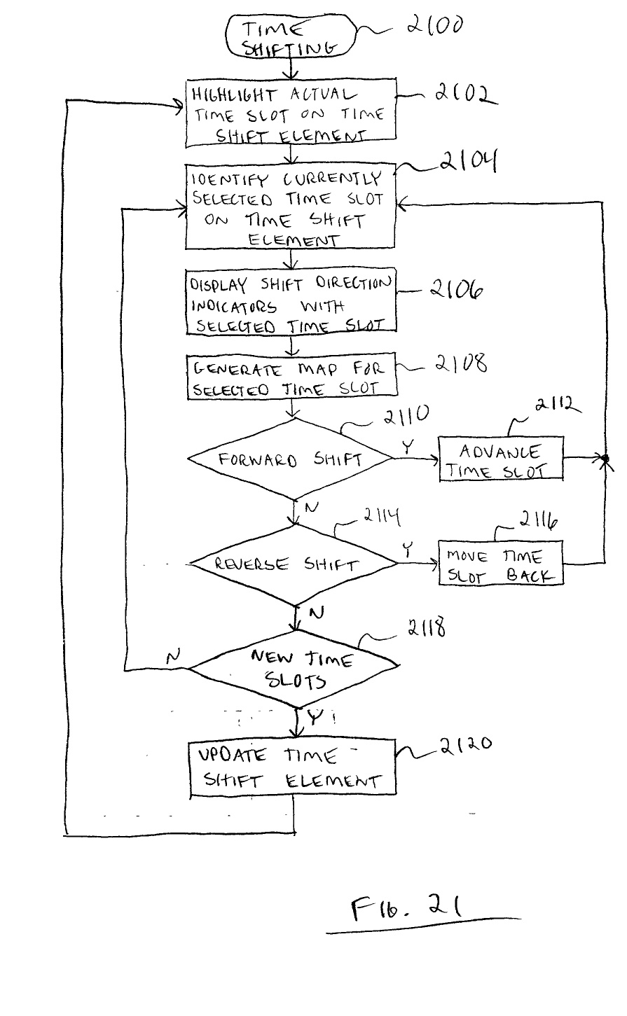

A query task 1324 may be performed to determine whether content or a file associated with a selected active map item has been requested by the end user. In the example embodiment, active element 110 (see FIG. 1) is selected by the user to request the currently selected active map item. If the presentation layer does not detect such a request, then map operation process 1300 may be re-entered at task 1302 to allow the end user to continue navigating the interface display. However, if a content/file request is received, then a task 1326 can be performed to provide the requested file or content to the end user in an appropriate manner. As described above, the specific type and format of file or content associated with a map item may vary depending upon how the display system is deployed. For example, an active map item may link to a cable television program, a digital music file, a radio station, an on-demand pay per view movie, a web site, a locally stored file, an applet, a digital picture, or the like. In this example, the program “Friends” on the NBC network affiliate Channel 4 will be shown in response to the user's activation of active element 110. The processing of an activation request is also described below in connection with FIG. 20.

In connection with task 1326, display system 500 may prompt the local launching of any number of applications designed to accommodate the playback of streaming media files (e.g., MP3 audio files, MPEG video files, AVI video files, or the like), the viewing of graphics files (e.g., bit map files, JPEG files, ACROBAT files, or the like), or the presentation of other files (e.g., word processor documents, spreadsheets, or the like). Alternatively, task 1326 may prompt the presentation device to switch from the navigation display system mode to the presentation mode. For example, in a set-top television embodiment, task 1326 may cause the set-top presentation layer 1000 to display the selected program on the television monitor 1006 or in a portion thereof. The set-top television embodiment may also respond to task 1326 by displaying a pop-up menu that provides recording options to the user. In addition, the presentation layer may hide the navigation map from view or delegate it to a smaller portion of the display screen, e.g., in a picture-in-picture window. Yet another embodiment may prompt the presentation of the requested content on a display element or device that is controlled by, but distinct from, the navigation display system 500.

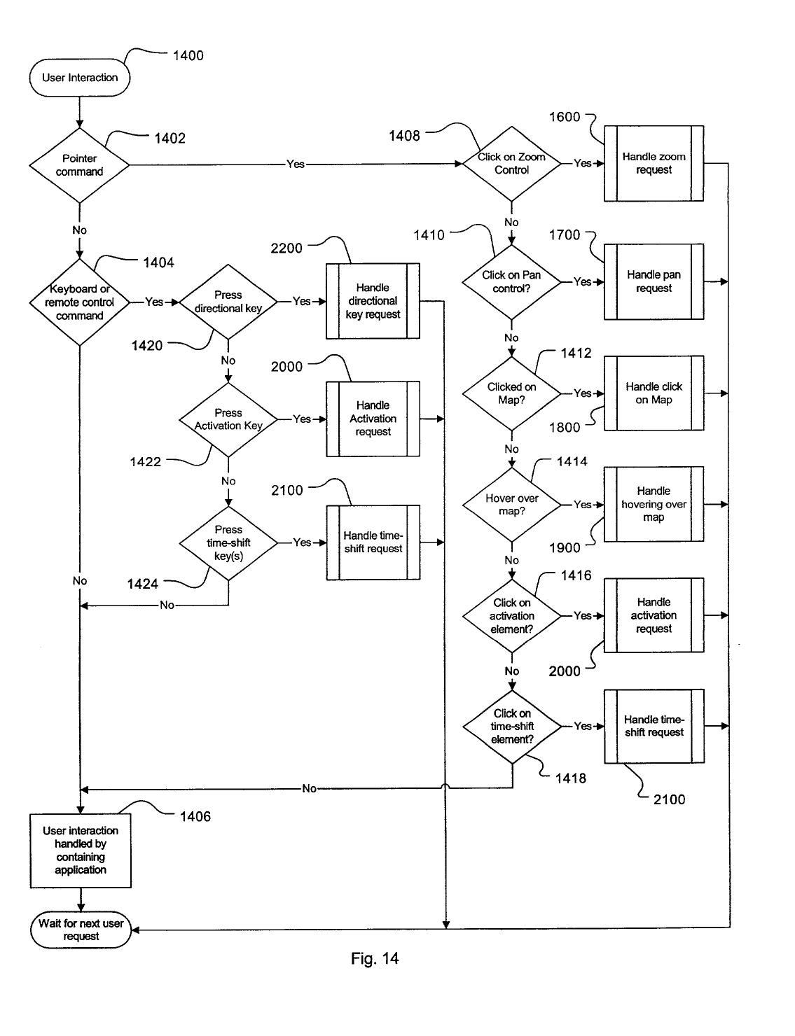

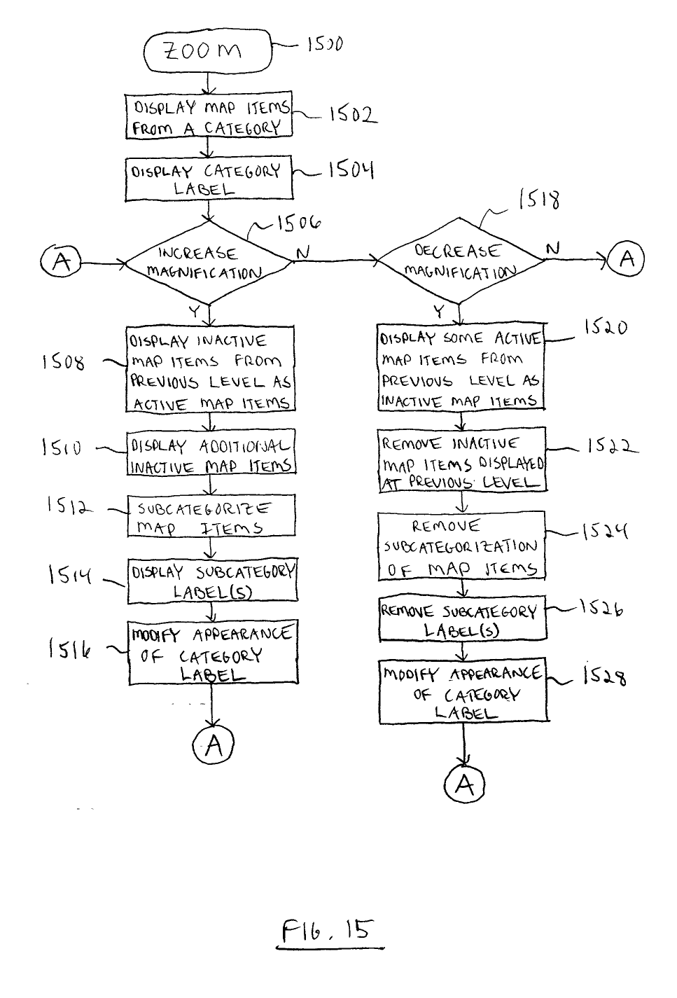

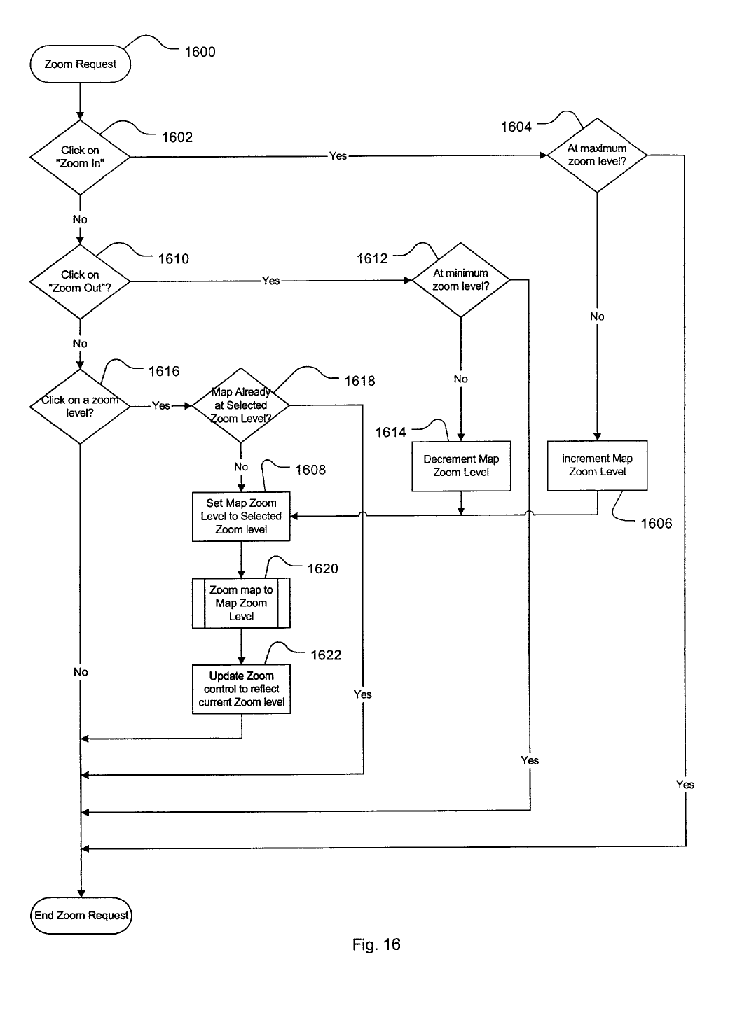

FIG. 14 is a flow diagram of a user interaction process 1400 that may be performed by navigation interface display system 500. Process 1400 relates to a number of requests or commands that may be generated by the end user while interacting with a navigation map (thus, process 1400 may be performed in conjunction with map operation process 1300). Process 1400 contemplates end user interaction with a navigation map display via a suitable pointing device and via a keyboard, keypad, or remote control device.

A query task 1402 determines whether the end user has entered a pointer command or request, e.g., a control signal produced in response to interaction with a pointing device such as a mouse, a touchpad, a joystick, a trackball, or the like. If so, then user interaction process 1400 may perform any number of tasks to monitor for different types of control commands. If not, then process 1400 may proceed to a query task 1404 to determine whether the end user has entered a keyboard (or remote control) command. If the navigation display system detects a keyboard command, then process 1400 may perform any number of tasks related to different types of keyboard entries. If process 1400 does not detect a pointer command or a keyboard command, then end user interaction may be handled by one or more other applications (task 1406). For example, a containing application or an operating system may also control and process certain end user commands that affect the navigation display system or the rendering of elements on the navigation map.

As mentioned above, any number of end user requests and commands may be generated in response to user interaction with a pointing device. Such interaction typically involves the movement of a cursor on the display screen and the selection of an active element or icon that is identified by the cursor. The selection of an active element in this manner is often referred to as “clicking” on the element. In other words, an end user may use a mouse to point to an active element and to click on the active element.

For example, if the end user clicks on a zoom control element rendered on a navigation map display (query task 1408), then the system may handle the zoom request in a suitable manner. An exemplary zoom request process is described below in connection with FIG. 16. As another example, if the end user clicks on a pan or directional control element rendered on the navigation map display (query task 1410), then the system may handle the pan request in an appropriate manner. An exemplary pan request process is described below in connection with FIG. 17.

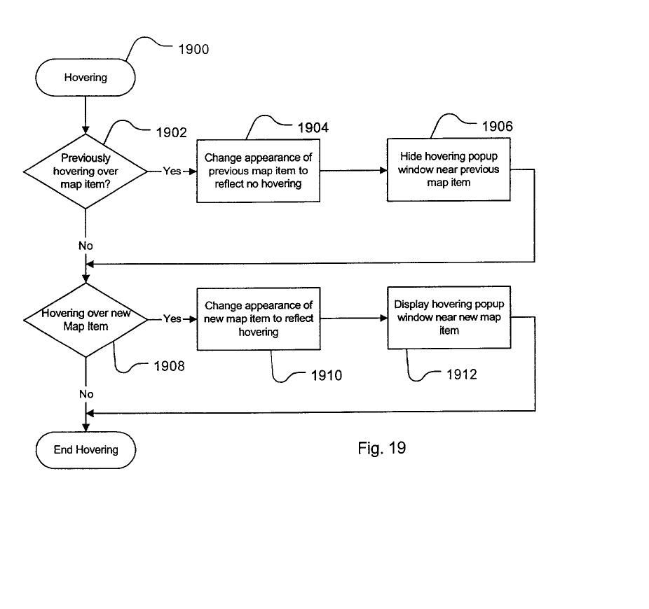

If the end user clicks on a portion of the rendered navigation map (query task 1412), then the system may perform different functions depending upon the specific area or element that the end user has selected. For example, an end user can click on an active map item, an inactive map item, a region of the map, or a dormant/inactive section of the map. One suitable process for handling on-map selections is described below in connection with FIG. 18. As described herein, navigation interface display system 500 may be configured to generate labels, pop-up windows, and other visual indicia as the end user traverses the map with a pointing device. Accordingly, if the en user hovers the pointing device over certain portions of the map (query task 1414), then the system may react in a suitable manner. For example, the system may respond in accordance with the hovering process described below in connection with FIG. 19.

If the end user clicks on an activation element rendered on the navigation display (query task 1416), then navigation interface display system 500 preferably handles the activation request to provide the requested content to the end user. As described above in connection with FIG. 1, activation element 110 preferably causes the launching, downloading, streaming, or transmission of the selected or highlighted content for enjoyment by the end user. An exemplary activation request process is described below in connection with FIG. 20.

As described above in connection with FIGS. 11 and 12, the navigation interface display may include a time-shifting element 1100 that causes the navigation map to display programming for different time slots. Thus, if the end user clicks on a time-shift element (query task 1418), then navigation interface display system 500 handles the time shifting request in a suitable manner. For example, system 500 may perform a time shift request process as described below in connection with FIG. 21.

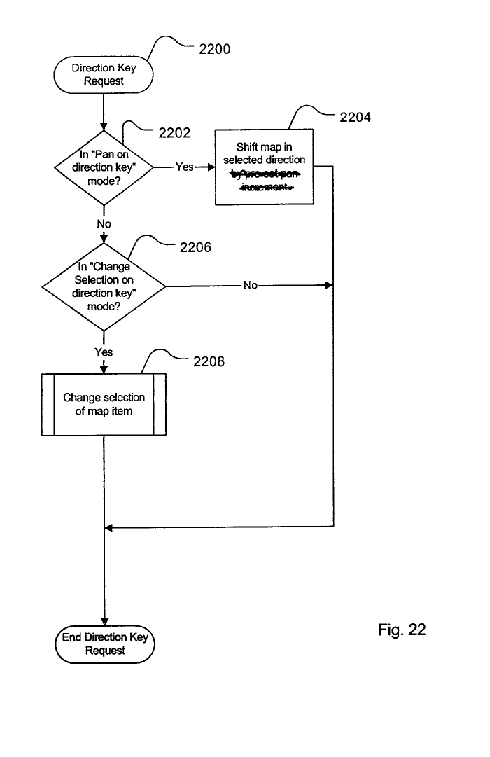

In addition to (or in lieu of) the various pointer commands described above, a practical system may include a number of features and functions that respond to keyboard or keypad entries. Such command entries may be associated with a single key entry, a key sequence, or a combination of key entries. For example, if the end user presses a directional key (e.g., an arrow key, a page up key, a page down key, etc.), then navigation interface display system 500 may handle the directional key request in a suitable manner (query task 1420). An exemplary directional key process is described below in connection with FIG. 22.

If the end user presses an activation key (query task 1422), then user interaction process 1400 may prompt the activation request process to provide the selected content to the end user. In a practical embodiment, the activation key is the “ENTER” key and engaging the “ENTER” key causes the currently selected file, channel, or station to be activated. In this respect, engaging the activation key is equivalent to clicking an activation element rendered on the navigation display (see query task 1416).

If the end user presses a time shift key (query task 1424), then user interaction process 1400 may prompt the time shift request process to change the time slot or time period associated with the currently displayed map. In practice, any suitably designated key, key sequence, or combination of keys may be associated with the time shifting feature. For example, the end user may press a directional key to select an appropriate time slot, then press the “ENTER” key to activate the time shifting feature. In this respect, engaging the time shifting key (or keys) is equivalent to clicking time-shifting element 1100 rendered on the navigation display (see query task 1418).

After handling the current end user command or request, user interaction process 1400 may idle or wait for the next user request. Thus, the various handling procedures of process 1400 may be repeated as the end user interacts with the navigation map display. It should be appreciated that a practical system may include any number of selectable or active elements and features that respond to end user interaction. Indeed, the specific functions described above intended to limit or otherwise restrict the present invention, and a number of alternative or additional features may be incorporated into user interaction process 1400. For example, although not shown in FIG. 14, keyboard entries may also be used to control zooming, hovering, and other features described above in connection with the pointer command controls.

FIG. 15 is a flow diagram of an exemplary zoom process 1500 that may be performed in the context of the present invention. A task 1502 causes the navigation interface display system to suitably display a graphical feature along with a number of map items associated with a category. In this respect, task 1502 causes a navigation map to be displayed at a particular level of magnification. For illustrative purposes, process 1500 is described herein in the context of a number of discrete magnification levels. However, as mentioned above, the present invention is not limited to such an embodiment. Indeed, alternate embodiments of the invention may utilize a substantially seamless or continuous magnification scheme in lieu of designated levels. Those skilled in the art will appreciate that process 1500 can be modified for equivalent application to such alternate embodiments. In practice, the presentation layer and the presentation device performs the navigation map displaying tasks described herein.

For the sake of brevity and simplicity, process 1500 is described herein in the context of one category and one “region” of a navigation map, namely, graphical feature 122. In the example display screens shown in FIGS. 1 and 3, graphical feature 122 is generally associated with the category “Movies.” Of course, the features associated with process 1500 may be equivalently applied to any number of graphical features, map items, and categories. In navigation map 108, graphical feature 122 is rendered with a number of active map items (such as active map item 114) and a number of inactive map items (such as inactive map item 134). The distribution of active and inactive map items on a region may vary depending upon the current magnification level of the navigation map. For example, at the very lowest level of magnification, there may be little or no active map items displayed. In contrast, at intermediate levels of magnification, there may be a blend of active and inactive map items. In addition, at the highest level of magnification (which corresponds to the highest level of detail), there may be little or no inactive map items displayed.

In addition to task 1502, zoom process 1500 may perform a task 1504 to suitably display a category label on or proximate to the graphical feature. In the example embodiment, graphical feature 122 is identified by the category label “Movies.” At the level of magnification shown in FIG. 1, no other category labels are displayed in connection with graphical feature 122. Alternatively, a single graphical feature (such as graphical feature 118) may be divided into any number of areas or regions that represent any number of distinct or related categories or subcategories. Accordingly, graphical feature 118 includes a number of category and/or subcategory labels: “Network,” “Variety,” and “Comedy.”

As described above, the navigation interface display system is suitably configured to allow an end user to increase and decrease the level of magnification of the navigation maps. The magnification levels may be discrete in number, or the display system may be capable of rendering navigation maps having substantially continuous and seamless variations in magnification. Different magnification levels may be selected by discrete icons or virtual buttons (such as those shown in FIGS. 13), by selecting a region on the navigation map with a pointing device or remote control device, or by any suitable magnification control signal source. In this regard, if a query task 1506 determines that an increase magnification control signal has been received by the presentation layer, then a task 1508 may be initiated. If not, then a query task 1518 (described below) is performed.

In response to the increase magnification signal, the presentation layer and/or the map system cause the navigation map to be magnified and rendered in more detail. In the current example, FIG. 1 represents a relatively low magnification level, FIG. 2 represents a relatively intermediate magnification level, and FIG. 3 represents a relatively high magnification level. In addition to the general magnification of the navigation map, task 1508 causes the presentation layer and/or the map system to display inactive map items from the “previous” level as active map items on the current level. In other words, the number of active map items on a given graphical feature preferably increases as the magnification level increases. In the example embodiment, a transition from one magnification level to the next higher magnification level results in the conversion all of the inactive map items from the previous level into active map items at the subsequent level. The same characteristic preferably applies when the end user desires to “skip” a magnification level. However, in addition to the rendering of inactive map items as active map items, skipping over a magnification level may cause an additional number of active map items to appear on the resultant map. Such additional active map items may be associated with the inactive map items that would have been displayed at the skipped magnification level. A task 1510 may also be performed to cause the presentation layer and/or the map servers to display additional inactive map items at the resultant magnification level. These additional inactive map items preferably represent map items that will be rendered as active map items at higher magnification levels.

In addition to (or in place of) tasks 1508 and 1510, zoom process 1500 may perform a task 1512, which causes the presentation layer and/or the map system to subcategorize a number of map items according to an appropriate scheme. As described above, a category such as “Movies” may be further divided into any number of subcategories, e.g., “Drama,” “Mystery,” and the like (see FIG. 3). In this respect, task 1512 may suitably separate or group active (or inactive) map items according to a more detailed subcategory. Thus, map items within the subcategory of “Drama” may be located proximate to a first area on the graphical feature, while map items within the subcategory of “Mystery” may be located proximate to a second area on the graphical feature. The arrangement of map items with respect to subcategories and respective areas on a graphical feature may be a by-product of the navigation map design. Alternatively, the map items can be dynamically grouped and positioned on a graphical feature in response to magnification level changes, other real-time operating parameters, user preferences, or any map item filtering protocol. As described above, the navigation interface display system may be configured to render dividing lines on the navigation map to further distinguish such subcategories. A task 1514 may also be performed to display the subcategory label or labels on or proximate to the particular areas of the graphical feature, as shown in FIG. 3.

According to one aspect of the present invention, a task 1516 may be performed to suitably modify the appearance of a category label if desired. For example, at higher magnification levels, the label associated with a category may be repositioned, reduced, or removed to avoid the display of unintelligible portions of a word or truncated letters. Such modification of the broader category label may also be desirable to provide additional space on the navigation map for more map items and subcategory labels. Following task 1516, zoom process 1500 may be re-entered at query task 1506.

As briefly mentioned above, query task 1518 is performed if query task 1506 does not detect an increase magnification control signal. If query task 1518 detects a decrease magnification control signal from the end user, then a task 1520 may be initiated. Otherwise, zoom process 1500 may be re-entered at query task 1506. In response to the decrease magnification request, the display system renders the navigation map in less detail than the previous rendering. In addition, task 1520, which is preferably performed by the presentation layer or by the map system, displays some of the active map items from the previous magnification level as inactive map items at the resulting lower magnification level. Alternatively, task 1520 may cause some of the active map items from the previous level to be removed or hidden from view. In the example embodiment, this characteristic is exhibited when the user skips one or more levels while decreasing magnification of the map. This characteristic is apparent in the transition from FIG. 3 to FIG. 1.

A task 1522 may also be performed to remove inactive map items displayed at the previous level such that they are not displayed at the decreased magnification level. Although not reflected in FIGS. 1-3, an alternate embodiment may preserve inactive map items for more than one magnification level. In view of the decreased magnification and decreased level of map detail, a task 1524 may be performed to remove one or more subcategorization schemes associated with the map items rendered on the given graphical feature. Task 1524 may remove dividing lines rendered at the previous magnification level, regroup map items in a consolidated or generalized manner, or the like. In addition, zoom process 1500 may perform a task 1526 to suitably remove one or more subcategory labels related to the map items. The detailed information conveyed by such labels may not be desirable or necessary at the resulting magnification level. Finally, as described above in connection with task 1516, the presentation layer and/or the map system may modify the appearance of the category label if necessary to restore its format to one suitable for the lower magnification level (task 1528). Following task 1528, zoom process 1500 may be reentered at query task 1506.

FIG. 16 is a flow diagram of a zoom request process 1600. Process 1600 may be performed in response to an end user zoom command (see FIG. 14 and related description). Consequently, process 1600, or portions thereof, may be performed in conjunction with zoom process 1500.

Zoom request process 1600 may determine (query task 1602) whether the end user has selected or clicked on a “zoom in” element, e.g., element 436 shown in FIG. 4. If so, then a query task 1604 may be performed to test whether the navigation map is currently displayed at the maximum zoom level. If the map is already at its maximum zoom level, then zoom request process 1600 ends and waits for the next zoom request. However, if the map is not at the maximum zoom level (i.e., it is possible to magnify a displayed portion of the map), then process 1600 increments the map zoom level (task 1606). In addition, process 1600 may set the map zoom level to the newly-selected zoom level (task 1608).

If the end user has not initiated a “zoom in” request, then the navigation interface display system tests whether the end user has initiated a “zoom out” request (query task 1610). Thus, if the end clicks on a “zoom out” element, e.g., element 434 in FIG. 4, then zoom request process may perform a query task 1612 to determine whether the navigation map is currently being displayed at its minimum zoom level. If the map is already at its minimum zoom level, then zoom request process 1600 exits. In contrast, if the map is not at its minimum zoom level (i.e., the map can be modified to show less detail), then the navigation system decrements the current map zoom level (task 1614) and sets the map zoom level to reflect the change (task 1608).

As described above in connection with FIG. 4, the zoom control tool 406 may also include a number of user-selectable zoom levels. Consequently, zoom request process 1600 also tests whether the end user has selected a particular zoom level (query task 1616). If not, then process 1600 exits and waits for the next zoom request. On the other hand, if the end user clicks on a specific zoom level element, then the navigation system may analyze whether the current map is already displayed at the selected zoom level (query task 1618). If so, then process 1600 exits. If not, then process 1600 leads to task 1608 to set the displayed map zoom level to the newly-selected level.

Once the navigation system sets the new map zoom level, a task 1620 is performed to zoom the map to the current level. In this respect, task 1620 may incorporate some or all of the process tasks described above in connection with FIG. 15. In addition, zoom request process 1600 preferably updates the appearance of zoom control tool 406 (see FIG. 4) to reflect the current zoom level of the navigation map (task 1622).

FIG. 17 is a flow diagram of a pan request process 1700 suitable for use in connection with user interaction process 1400. As described above, process 1700 may be performed in response to the receipt of a map panning or directional control signal generated by a presentation device. In response to such a request, the navigation system shifts the current map in the selected direction by a suitable pan increment (task 1702). In a practical embodiment, the panning increment is predetermined and fixed for a given zoom level. Alternatively, the panning increment may be variable to facilitate enhanced navigation by the end user. Eventually, the navigation system redraws the map to reflect the new view (task 1704). Thus, the navigation system may add or remove map items or regions to reflect the current state of the displayed map.

FIG. 18 is a flow diagram of an on-map selection process 1800 that may be performed in the context of user interaction process 1400. Process 1800 may be performed when the end user clicks on the map area of the navigation display. As described herein, the navigation system reacts differently in response to the particular area, icon, or element selected by the end user.

On-map selection process 1800 may begin with a query task 1802, which tests whether the end user has selected or clicked on an active map item contained in the displayed navigation map. If so, then the navigation system checks whether the selected map item is the currently selected map item (query task 1804). Thus, process 1800 ends if the end user has merely reselected an active map item. However, if the end user has clicked on a new active map item, then process 1800 causes the navigation system to change the selection to the newly-selected map item. An exemplary change selection process is described below in connection with FIG. 23.

If the end user did not select an active map item, then on-map selection process 1800 determines (query task 1806) whether the end user has clicked on a different portion of the map, e.g., a portion of the map that does not indicate an active map item. For example, an end user may click on a region or an area of the map that does not contain any active map items. As another example, the end user may click on a portion of a region to highlight or focus on a subcategory or a sub-region. If the end user selects a portion of the map, then a query task 1808 may be performed to check whether the navigation system is in a “zoom upon click” mode. As described above, this mode allows the user to automatically zoom into an area of the map by clicking on the map. If the system is in this mode, then a query task 1810 may be performed to determine whether the map is already at its maximum zoom level. If the zoom level is already maximized, then process 1800 ends. If not, then the navigation system may increment the map zoom level (task 1812) and modify the displayed map in an appropriate manner (as described above).

If the system is not functioning in the “zoom upon click” mode, then a query task 1814 can be performed to determine whether the system is functioning in a “center on click” mode. As described previously, this mode preferably enables an end user to re-center the map about a selected point. For example, in response to an end user selection of a point on the map, the navigation system may center the map on the selected point and redraw the map to reflect the changed status (task 1816). If the system is not functioning in the “center on click” mode, then on-map selection process 1800 ends.

FIG. 19 is a flow diagram of a hovering process 1900 that may be performed by the navigation system in response to movements of an end user controlled pointing device (see FIG. 14). For example, if the end user moves an on-screen cursor or pointer over certain display elements, the system may react by generating labels, creating messages, or otherwise modifying the appearance of the map.

Hovering process 1900 may begin by analyzing whether the pointer was previously hovering over a map item (query task 1902). If so, then the navigation system changes the appearance of the previous map item to reflect no hovering (task 1904). For example, the navigation system may highlight a map item icon when the pointer is hovering over or proximate to the icon. When the pointer moves away from the map item, task 1904 preferably changes the appearance such that the previous map item is no longer highlighted. In addition, a task 1906 may be performed to hide any hovering pop-up windows associated with the previous map item. In a practical embodiment, task 1906 causes pop-up windows or text boxes located near the previous map item to disappear.

A query task 1908 tests whether the current position of the end user pointer is hovering over or proximate to a new map item. If so, then the navigation system preferably changes the appearance of the new map item to reflect the hovering (task 1910). As mentioned above, task 1910 may highlight, color, or otherwise alter the display of the new map item while the pointer hovers over or proximate to the new map item. In addition, a task 1912 may be performed to display a hovering pop-up window, label, or text box near the new map item. The pop-up window may contain information or data related to the channel or station represented by the new map item, e.g., the station name or call letters, the type of content available, the name of the program of file that is currently available, the start/stop times of the current program, or the like. In this manner, the end user can quickly and easily determine the status of a number of channels or stations by traversing the navigation map with a pointing device.

FIG. 20 is a flow diagram of an activation request process 2000 that may be performed in the context of user interaction process 1400. As described in connection with process 1400, activation request process 2000 may be performed in response to an end user keyboard entry or in response to a control signal from a pointing device. Regardless of the manner in which the end user enters an activation request, process 2000 preferably determines whether a map item is currently selected (query task 2002). If no map item is currently selected, then process 2000 may cause the navigation system to notify the user that a map item must be selected to carry out the activation function (task 2004). The system may notify the end user in any suitable manner. For example, the system may generate an error message or a warning sound, change the appearance of one or more features of the navigation map, or the like.

If the activation request is associated with a selected map item, then a task 2006 may be performed. Task 2006 may notify an appropriate application that a map item has been activated. In the preferred embodiment, an item-specific activation action is initiated to commence playback, downloading, streaming, or transmission of the content associated with the selected map item. As described above in connection with process task 1326 (see FIG. 13), the presentation device may jump to a specific web page, display the streaming content, launch any number of media playback applications, or the like. In other words, task 2006 causes the presentation device to present the selected content or file to the end user.

FIG. 21 is a flow diagram of a time shifting process 2100 that may also be performed in connection with user interaction process 1400. Time shifting process 2100 may be performed in response to an end user keyboard entry or in response to a control signal from a pointing device. As described above with regard to FIGS. 11 and 12, time shifting process 2100 is preferably responsive to end user interaction with a time-shift element contained in the navigation display.

Regardless of the manner in which the end user enters a time shifting request, time shifting process 2100 preferably begins by highlighting or otherwise indicating the actual current time slot on the time-shift element (task 2102). As described above in connection with FIGS. 11 and 12, the preferred embodiment highlights the actual time slot with shading or coloring, and maintains the highlighting while the actual time slot remains current. Process 2100 also identifies the currently selected time slot on the time-shift element (task 2104). Since the currently selected time slot can be controlled by the end user, the navigation system identifies the current time slot in a suitable manner. For example, task 2104 may cause the current time slot to be highlighted, outlined, boldfaced, or colored differently than the remaining time slots.

Time shifting process 2100 may also cause the navigation system to render a number of shift direction indicators along with the currently selected time slot (task 2106). As shown in FIG. 11, a single direction indicator (e.g., an arrow) may be displayed if the selected time slot is the first or last slot on the time-shift element. Alternatively, as shown in FIG. 12, two directional indicators may be displayed if the selected time slot is an intermediate slot on the time-shift element. These directional arrows indicate whether the current time slot can be advanced or reversed.

The navigation system preferably generates a navigation map for the selected time slot (task 2108) for presentation to the end user. In accordance with one practical embodiment, time shifting process 2100 initially defaults to the actual time slot, automatically selects the actual time slot, and generates a “real-time” map for display during task 2108. If process 2100 detects a forward shift request from the presentation device (query task 2110), then the current time slot will be advanced by the appropriate number of slots (task 2112). Thereafter, process 2100 may be reentered such that tasks 2104, 2106, and 2108 can be repeated for the newly-selected time slot. In response to a newly-selected time slot, task 2108 causes the navigation system to modify the status of the map items, programming information, pop-up labels and boxes, preview window, and/or other time-sensitive data rendered on the displayed map. In a similar manner, a reverse shift request from the presentation device (query task 2114) causes the current time slot to be moved back by the appropriate number of slots (task 2116). Ultimately, a time reversal command will update and modify the navigation map to reflect the newly-selected time slot.

As the actual time progresses, the current time slot, a past time slot, or whichever time slot indicates the earliest period of time, may become stale or outdated. For example, the time-shift element 1100 of FIG. 11 includes six discrete time slots. Over time, the earliest time slot will no longer be relevant. Accordingly, time shifting process 2100 preferably tests whether new time slots are to be displayed (query task 2118). If not, then process 2100 may be re-entered at task 2104 to continue monitoring for time shifting requests from the end user. If query task 2118 determines that one or more new time slots should be displayed, then the navigation system updates the time-shift element 1100 in a suitable manner (task 2120). For example, task 2120 may remove the earliest time slot (e.g., the 8:00 PM slot shown in FIG. 11), shift the remaining time slots to the left, and add a new time in the latest time slot (e.g., an 11:00 PM time slot). Thus, the time-shift element may be dynamically updated in a substantially real-time manner. After the time-shift element is updated, time shifting process 2100 may be re-entered at task 2102 to highlight the new actual time slot.

FIG. 22 is a flow diagram of a directional key request process 2200 that may be performed by the navigation system in response to a directional key entry by an end user (see FIG. 14). If the navigation system is in a “pan on direction key” mode (query task 2202), then the system shifts the map in the selected direction by an appropriate panning increment (task 2204). In this context, the selected direction corresponds to the particular directional key engaged by the end user (e.g., up, down, left, or right). The panning increment may be predetermined and fixed, or it may be dynamically responsive to other end user commands or preferences. In response to the directional key request, the navigation system updates the current map display to reflect the incremental shift.

If the navigation system is not in the “pan on direction key” mode, then a query task 2206 may be performed to determine whether the system is in a “change selection on direction key” mode. If not, then direction key request process 2200 may end. Otherwise, process 2200 may prompt the navigation system to change the currently selected map item to another map item (task 2208). In accordance with the preferred embodiment, task 2208 selects a map item associated with one of the directional indicators rendered on the map display (see guidance indicators 430 in FIG. 4). For example, in a practical embodiment, task 2208 will select one of the four neighboring map items associated with the up, down, left, and right directional keys.

FIG. 23 is a flow diagram of a change selection process 2300 that may be performed by a navigation system according to the present invention. Process 2300 is performed when an end user selects a map item displayed on the current navigation map. For example, process 2300 may be performed in conjunction with on-map selection process 1800 (see FIG. 18).

Change selection process 2300 may begin with a query task 2302, which tests whether the navigation map included a previous map item selection. If so, then process 2300 may take steps to eliminate features corresponding to the previously selected map item. For example, the navigation system may de-select the previous map item such that the previous map item is no longer displayed as a selected map item (task 2304). In this respect, task 2304 may remove any special highlighting, coloring, shading, or additional display elements that would otherwise be associated with a selected map item. In addition, if the navigation system is in a “show guidance indicators” mode (query task 2306), then process 2300 may hide or remove the previous guidance indicators associated with the previous map item (task 2308).

If query task 2302 determines that there is no previous map item selection, then change selection process 2300 preferably tests whether the end user makes a new selection (query task 2310). If not, then process 2300 ends. If the end user makes a new selection, then process 2300 proceeds to change the selected map item. In accordance with one practical embodiment, a query task 2312 determines whether the navigation system employs a “show selection” area or window. A “show selection” area may be a rectangle or other boundary that governs whether or not a selected map item can be adequately displayed to the end user. For example, if a map item is only partly shown on the edge of the navigation map, then it may not be within the “show selection” window. In contrast, a map item that is centered in the navigation map will most likely be contained within the “show selection” area. If the new selection is within the “show selection” area (query task 2314), then process 2300 may proceed to a task 2318. If the new selection is outside of the “show selection” area, then the navigation system may shift, pan, or adjust the map to ensure that the new selection is contained within the “show selection” area (task 2316).

Task 2318 may be performed to add a selection graphic to the newly selected map item or to otherwise change the appearance of the newly selected map item. As described above, a selected map item may be highlighted with shading, coloring, text, additional graphic elements, or the like. In the preferred embodiment, task 2318 causes the navigation system to distinguish the newly selected map items from the remaining map items in a visible manner.

If the navigation system is in the “show guidance indicators” mode (query task 2320), then new guidance indicators may be displayed in connection with neighboring map items (task 2322). In a practical embodiment, task 2322 determines a logical mapping for each of the new guidance indicators corresponding to the directional keys utilized by the respective presentation device. For example, up to four new guidance arrows may be displayed; one for each cardinal direction.

In response to the new map item selection, the navigation system may also update a preview area (e.g., preview area 412 in FIG. 4) to display, show, or play content related to the newly selected channel, station, or file (task 2324). In addition, change selection process 2300 may update the content description area 410 (task 2326) and/or the map item information area 408 (task 2328) as necessary. Task 2326 may update the description area 410 with information related to the current program or file corresponding to the new map item, and task 2328 may update the information area 408 with programming or control information associated with the newly selected station or channel.

FIG. 24 is a flow diagram of a navigation map presentation process 2400 that may be performed by a practical embodiment of the present invention. Process 2400 assumes that the navigation interface display system is configured in accordance with the layered architecture techniques described above. Although not a requirement of the display system, process 2400 is described herein in the context of a deployment to support one system administrator, e.g., one broadcast service provider such as a cable television company. In other words, although one display system may be deployed in a manner that supports a plurality of service providers, a realistic practical implementation will enable one service provider to support its subscribers in a centralized manner.

Map presentation process 2400 preferably begins with a task 2402, during which map databases 508 (see FIG. 5) receive and store generic map data associated with one or more deployed navigation maps. In the context of a deployment by a single service provider, map databases 508 may include generic map data related to any number of different users (indeed, each user may have a unique set of map preferences maintained by display system 500). Map databases 508 may also contain generic map data related to any number of different map preferences, configurations, designs, or the like, where such different maps need not be associated with specific end users.

Due to the preferred server-based architecture of the display system 500, a map servers 504 receive a map request from an end user (task 2404) who wishes to view a particular navigation map. In the practical embodiment, such map requests are generated by the respective presentation layer. The map request includes a suitable map identifier, such as a URL, that enables map servers 504 to extract the appropriate data from map databases 508. A task 2406 is performed to retrieve the generic map data (from map databases 508) associated with the requested navigation map. As described above, map servers 504 may utilize any number of known database management techniques to communicate with and extract data from map databases 508.

If necessary, map presentation process 2400 performs a task 2408 to obtain content information from application databases 506. Task 2408 obtains the content data associated with the current map request. As described above, application databases 506 are typically externally-maintained databases associated with a specific presentation device, a particular content provider, or the like. For example, in a cable or satellite television deployment, an application database 506 may contain current programming data that is updated on a daily basis. In one practical embodiment, map servers 504 are suitably configured to interrogate application databases 506 and to extract the relevant data therefrom. Map servers 504 may process the relevant content data with the relevant generic map data during process 2400.

After map servers 504 obtain the content data and the generic map data, a task 2410 may be performed to suitably provide such data to the applicable presentation layer. As described above, any number of conventional data communication protocols can be employed to carry out task 2410. In particular, task 2410 preferably provides the generic map data and the content data to the application server associated with the respective presentation layer. In view of the generic nature of the map data, map servers 504 need not know the characteristics of the end user's presentation device or the ultimate format in which the map data will be provided to the presentation device. In the preferred embodiment, each application server is configured to recognize the generic map data format used by map servers 504. In addition, each application server is compatible with the corresponding presentation device. Accordingly, a task 2412 is preferably performed by an appropriate application server to convert the generic map data and the application or content data into a format suitable for use by the specific presentation device.

Eventually, a task 2414 is performed by the respective presentation device to suitably render the navigation map on the corresponding display element. In connection with task 2414, the respective application server has generated reformatted map data in a manner that is recognizable by the presentation device. Thus, the presentation device need not be specially configured to receive or process the map data. Rather, the presentation device merely renders the map data in a manner that is consistent with the rendering of other graphical elements on the display element.

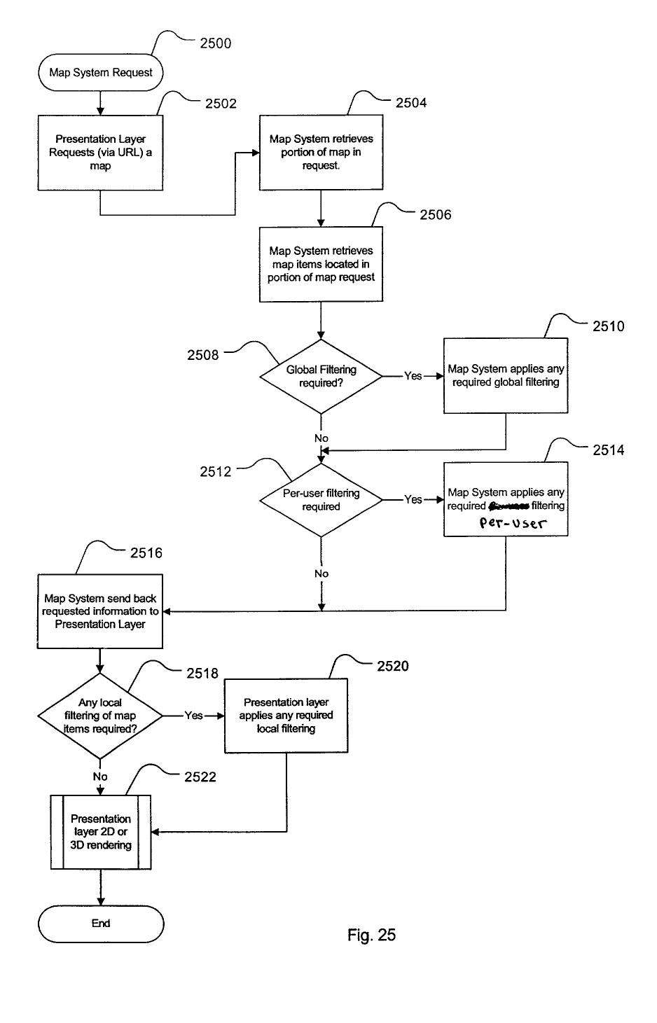

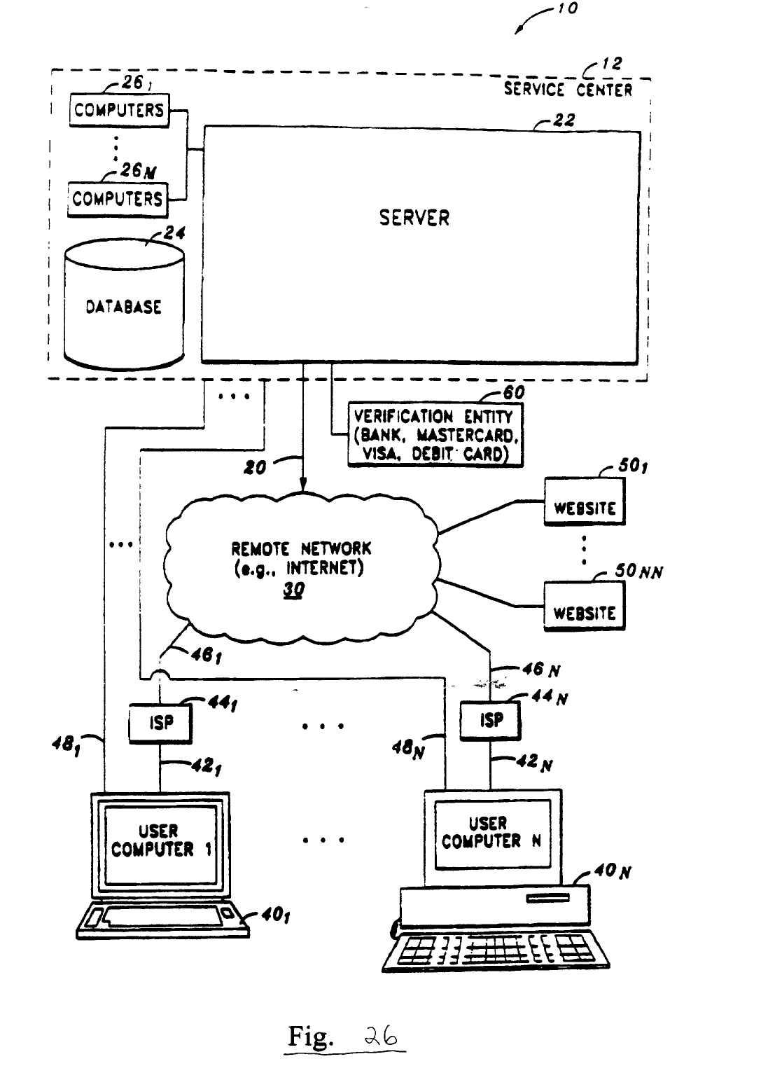

FIG. 25 is a flow diagram of a map system request process 2500 that may be performed by a navigation interface display system according to the present invention. Process 2500 (or portions thereof) may be performed in conjunction with map presentation process 2400. Process 2500 may begin when a presentation layer requests a navigation map (task 2502). In the preferred embodiment, each navigation map can be requested using a designated URL. In response to the map request, the map system retrieves at least a portion of the requested map (task 2504) and the map items located in that portion of the requested map (task 2506). Due to the potentially large map size, different zoom levels, and potentially large number of active and inactive map items, it may not be possible to efficiently retrieve all of the information associated with the requested map. Thus, tasks 2504 and 2506 enable the map system to retrieve a portion or a subset of the requested map. For example, tasks 2504 and 2506 may retrieve the lowest resolution map and a relatively small number of map items for initial display to the end user.

If global map item filtering is required (query task 2508), then a task 2510 may be performed to apply any necessary global filtering to the current navigation map. In addition, if per-user or individual map item filtering is required (query task 2512), then a task 2514 may be performed to apply such filtering. As described above, the map servers 504 preferably apply global filtering (i.e., filtering that is automatically applied to a number of users) and any user-specified or individual filtering to the requested map. The filtering may reduce the number of map items or otherwise modify the generic map data retrieved by the map system.

Eventually, the map system sends the map information back to the requesting presentation layer (task 2516). Thereafter, the presentation layer may test whether to apply local filtering to the received map items and/or to the received map data (query task 2518). If so, then the presentation layer can apply any required local filtering (task 2520). As mentioned previously, local filtering may be specific to the particular presentation layer, presentation device, or user preferences.

Following any local filtering, the presentation layer processes the navigation map information and renders the navigation map using any number of two-dimensional or three-dimensional graphics rendering techniques (task 2522). Of course, map system request process 2500 (or portions thereof) may be repeated for any number of subsequent map requests.

Streaming Media Portal

The techniques of the present invention may also be utilized in the context of a network portal or web site that manages access to any number of streaming media files. The following portion of this description and the corresponding figures constitute a portion of United States provisional patent application Ser. No. 60/195,955, the entire content of which is hereby incorporated by reference. For the sake of consistency with the remainder of this description, the following excerpt may differ from the provisional patent application with respect to formatting, figure numbering, and reference numbering. The following description of a specific implementation is not intended to limit the scope or application of the present invention.

One aspect of the invention involves a software application and Web site that offers directories of Internet radio stations, while facilitating the ability for the user to conduct “one stop shopping” with an easy to read, graphical display of all available stations, bandwidth information, and other germane data.

A second aspect of the invention involves the identification of the effect bit rate of streaming media on a global computer network such as the Internet. Currently, the published bit rate of streaming media on the Internet-it is not always as reliable as advertised. The published bit rate doesn't always reflect the effective bit rate users will experience. Because the load on the various servers will vary throughout the day, it is virtually impossible to predict the reliability of a given station. With multiple intermediary servers between the user and broadcaster operating under varying loads, the listener often experiences annoying breaks and skips in the broadcast, resulting in a diminished overall experience. To make the selection process even more arbitrary, many stations do not broadcast 24 hours a day. Some go offline periodically due to server glitches, some are “full” (meaning all their bandwidth is taken), etc.

As Web broadcasting increases in popularity, users will naturally require an easy-to-use mechanism for locating, filtering, and evaluating the status of available broadcasters. An ideal solution must meet the following criteria:

Present an interface that is fast, intuitive, and easy-to-use

Organize stations by broadcast genre

Suggest other stations that the user might enjoy

Identify stations broadcasting at a suitable bandwidth, i.e., fast enough to meet the user's minimum quality expectation, but not faster than their Internet connection will support

Evaluate connections in real-time to assure that stations are broadcasting reliably and that traffic permits a steady connection

Work with all available broadcast technologies-WMA, MP3, Real Audio, QuickTime, and any future media

A third aspect of the invention involves an apparatus and method for providing a user interface for selecting streaming media. Instead of taking a traditional hierarchical listing approach, the invention illustrates available sites using a unique, proprietary graphical user interface. In one embodiment, the graphical user interface is a map. This map will feature a mythical group of islands, continents, and seas, each with a set of radio towers representing available broadcasters.

Each region on the map will be labeled to represent a different genre, with broadcasters' radio towers located within the appropriate genre. Logical sub-regions will represent subsets of a genre. For example, one massive island will be called “Talk Land,” and represent talk radio stations. One portion of the island will be dedicated to sports talk, another will focus on Christian talk, and so on.

The map will be displayed with rolling hills, water, forests, deserts, and other terrain. Radio towers will be displayed as icons. The display will be dynamic and will reflect what is happening at the moment. The radio tower icons' appearance will change based on advertised bandwidth, whether the stations are currently broadcasting, whether they are full, whether they are marked as “favorites”, and other criteria. The user can zoom-in and zoom-out, scroll to other portions of the map, click on a radio tower to find out more information about the station, and access other related functions. The display will be “live” in that information displayed for the station will change dynamically as the station's status changes. For example, if a station becomes “full”, the icon will change immediately to reflect the new status.

This portal will be a completely Web-based application, and not require any additional software to be installed on the user's system. When the user click on the “Play” button to listen to a broadcast, the Web site which implements the principles of the invention will launch the appropriate application already installed on the user's computer (e.g. Windows Media Player, QuickTime, Real Player, etc.).

Definitions

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. Content refers to application programs, driver programs, utility programs, file, payload, etc., and combinations thereof, as well as graphics, informational material (articles, stock quotes, etc.) and the like, either singly or in any combination. A “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

System Overview

A description of an exemplary system, which incorporates embodiments of the present invention, is herein described. FIG. 26 shows a system block diagram of one embodiment of a network system 10 in which the system and methods of the invention are used. Referring to FIG. 26, the network system 10 comprises a service center 12 that is connected over one or more communication links 20 to a remote network 30 (e.g., a wide area network or the Internet) or a remote site (e.g., a satellite, which is not shown in FIG. 26) to one or more user computer systems 40₁-40_{N} (“40”). In one embodiment the service center 12 is a website. The service center 12 includes one or more servers 22 and one or more databases 24. In one embodiment, the server 22 includes software modules for performing the processes of the invention, as described in detail in the following sections.

The server 22 may be coupled to one or more verification entities such as entity 60 for verification of credit information and for processing credit transactions. The service center 12 may also include one or more computers 26₁-26_{M}. If a plurality of computers are used, then the computers 26₁-26_{M} may be connected by a local area network (LAN) or any other similar connection technology. However, it is also possible for the service center 12 to have other configurations. For example, a smaller number of larger computers (i.e. a few mainframe, mini, etc. computers) with a number of internal programs or processes running on the larger computers capable of establishing communication links to the user computers.

The remote network 30 or remote site allows the service center 12 to provide information and services to the user computers 40₁-40_{N}, using software that is stored at the service center 12. The one or more databases 24 connected to the service center computer(s), e.g., computer 26₁, are used to store database. Each user computer 40₁-40N is connected over a corresponding communication link 42₁-42_{N} such as a local carrier exchange to a respective ISP 44₁-44_{N}, through which access to the remote network 30 is made. By inputting the URL address of the target website with which the user desires to interact, the user may be cormected to various websites, such as websites 50₁-50_{NN}. In an alternate embodiment, each user may be connected over a corresponding communication link 48₁-48_{N} to the service center 12, which provides internet access and service to the user computer(s) 40. In a further embodiment, the display screen for viewing the graphical user interface of the invention may be located on a television coupled to the network 30. For example, the end user may be a viewer of a set top box television. In this case, navigation through the graphical user interface of the invention may be provided through the use of control buttons on a remote control unit for controlling viewing of the television, or by other means known in the art.

One aspect of the present invention relates to the development of software and a graphical user interface for presenting, locating, and identifying streaming media provided on a website. Such a development process may occur on a computer system that is separate and apart from the service center 12, or may be developed using one of the computers 26₁-26_{M}. Alternatively, the development process may occur on a computer that is not coupled to the communication network. Upon completion of the development process, the code may be stored in the database 24. Alternatively, the code may be stored on a machine-readable medium, such as a diskette, CD or DVD. In one embodiment, the service center 12 that is connected over one or more communication links to a remote network (such as the internet) may be requested to provide the code for use on a client website. In this embodiment, the code is stored on the database 24. Alternatively, the code may be provided on a machine-readable medium such as a diskette, a CD or DVD, for use by a client to enhance his/her website.

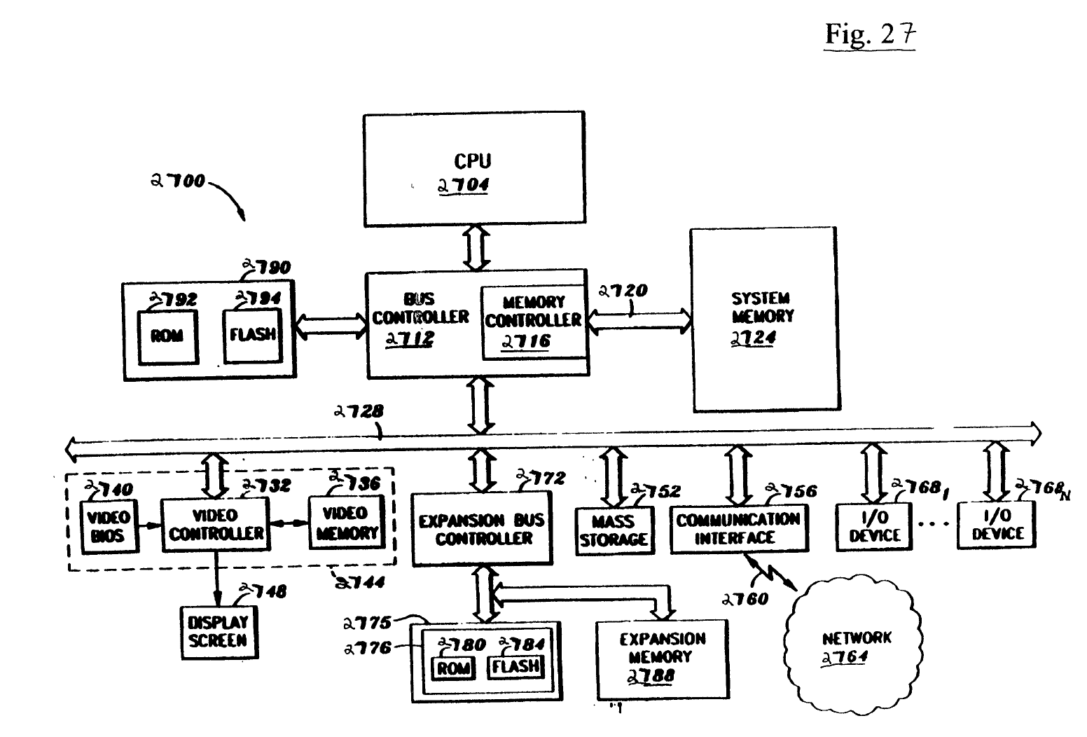

Referring to FIG. 27, the computer system 2700 (representing either of computer 26 or 40) comprises a processor or a central processing unit (CPU) 2704. The illustrated CPU 2704 includes an Arithmetic Logic Unit (ALU) for performing computations, a collection of registers for temporary storage of data and instructions, and a control unit for controlling operation for the system 2700. In one embodiment, the CPU 2704 includes any one of the ×86, Pentium™, Pentium II™, and Pentium Pro™ microprocessors as marketed by Intel™ Corporation, the K-6 microprocessor as marketed by AMD™, or the 6×86MX microprocessor as marketed by Cyrix™ Corp. Further examples include the Alpha™ processor as marketed by Digital Equipment Corporation™, the 680×0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 2704. The CPU 2704 is not limited to microprocessor but may take on other forms such as microcontrollers, digital signal processors, reduced instruction set computers (RISC), application specific integrated circuits, and the like. Although shown with one CPU 2704, computer system 2700 may alternatively include multiple processing units.

The CPU 2704 is coupled to a bus controller 2712 by way of a CPU bus. The bus controller 2712 includes a memory controller 2716 integrated therein, though the memory controller 2716 may be external to the bus controller 2712. The memory controller 2716 provides an interface for access by the CPU 2704 or other devices to system memory 2724 via memory bus 2720. In one embodiment, the system memory 2724 includes synchronous dynamic random access memory (SDRAM). System memory 2724 may optionally include any additional or alternative high speed memory device or memory circuitry. The bus controller 2712 is coupled to a system bus 2728 that may be a peripheral component interconnect (PCI) bus, Industry Standard Architecture (ISA) bus, etc. Coupled to the system bus 2728 are a graphics controller, a graphics engine or a video controller 2732, a mass storage device 2752, a communication interface device 2756, one or more input/output (I/O) devices 2768₁- 2768_{N,}and an expansion bus controller 2772. The video controller 2732 is coupled to a video memory 2736 (e.g., 8 Megabytes) and video BIOS 2740, all of which may be integrated onto a single card or device, as designated by numeral 2744. The video memory 2736 is used to contain display data for displaying information on the display screen 2748, and the video BIOS 2740 includes code and video services for controlling the video controller 2732. In another embodiment, the video controller 2732 is coupled to the CPU 2704 through an Advanced Graphics Port (AGP) bus.

The mass storage device 2752 includes (but is not limited to) a hard disk, floppy disk, CD-ROM, DVD-ROM, tape, high density floppy, high capacity removable media, low capacity removable media, solid state memory device, etc., and combinations thereof. The mass storage device 2752 may include any other mass storage medium. The communication interface device 2756 includes a network card, a modem interface, etc. for accessing network 2764 via communications link 2760. The I/O devices 2768₁-2768_{N} include a keyboard, mouse, audio/sound card, printer, and the like. The I/O devices 2768₁-2768N may be disk drive, such as a compact disk drive, a digital disk drive, a tape drive, a zip drive, a jazz drive, a digital video disk (DVD) drive, a magneto-optical disk drive, a high density floppy drive, a high capacity removable media drive, a low capacity media device, and/or any combination thereof. The expansion bus controller 2772 is coupled to non-volatile memory 2775, which includes system firmware 2776. The system firmware 2776 includes system BIOS, which is for controlling, among other things, hardware devices in the computer system 2700. The system firmware 2776 also includes ROM 2780 and flash (or EEPROM) 2784. The expansion bus controller 2772 is also coupled to expansion memory 2788 having RAM, ROM, and/or flash memory (not shown). The system 2700 may additionally include a memory module 2790 that is coupled to the bus controller 2712. In one embodiment, the memory module 2790 comprises a ROM 2792 and flash (or EEPROM) 2794.

As is familiar to those skilled in the art, the computer system 2700 further includes an operating system (OS) and at least one application program, which in one embodiment, are loaded into system memory 2724 from mass storage device 2752 and launched after POST. The OS may include any type of OS including, but not limited or restricted to, DOS, Windows™ (e.g., Windows 95™, Windows 98™, Windows NT™), Unix, Linux, OS/2, OS/9, Xenix, etc. The operating system is a set of one or more programs which control the computer system's operation and the allocation of resources. The application program is a set of one or more software programs that performs a task desired by the user.

In accordance with the practices of persons skilled in the art of computer programming, the present invention is described below with reference to symbolic representations of operations that are performed by computer system 2700, unless indicated otherwise. Such operations are sometimes referred to as being computerexecuted. It will be appreciated that operations that are symbolically represented include the manipulation by CPU 2704 of electrical signals representing data bits and the maintenance of data bits at memory locations in system memory 2724, as well as other processing of signals. The memory locations where data bits are maintained are physical locations that have particular electrical, magnetic, optical, or organic properties corresponding to the data bits.

When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed earlier, upon completion of the software and/or graphical user interface development process, the corresponding code may be stored in the database 24 or on a machine-readable medium. The code may then made available to users such as those located at user computer1- N, i.e., computers 40₁-40_{N} through service center 12 or by means of the machine-readable medium. If the software or graphical user interface is presented via the machine-readable medium, the computers 40₁-40_{N} may not necessarily be linked to the remote network for purposes of using the invention.

For present discussion purposes, a discussion of the viewing process through the service center 12 will be described in the following sections. In particular, after a user computer system 40 establishes two-way communications with the service center 12, the user is invited to select use of the programs developed and stored at the service center 12. In one embodiment, the user may be able to locate and identify streaming media using the graphical user interface of the invention, or to tune to one or more stations, or to download one or more programs as provided by the invention. Such downloading may occur either upon payment of a predetermined amount or upon signing on as a member of a program. The user may also be invited to make transactions such as purchasing of additional services or goods. In making payments or purchases, verification of the user's identity or credit may be provided via verification entity 60.

### EXEMPLARY IMPLEMENTATIONS

The Web portal of the invention allows listeners of live streaming audio (Internet Radio) to achieve the following objectives easily and quickly:

Present a user interface that displays the thousands of available stations efficiently, but doesn't overwhelm the user with information.

Quickly find Internet Radio Broadcasters (“stations”) by genre.

Identify stations broadcasting at a suitable bandwidth, i.e., fast enough to meet the user's minimum quality expectation, but not faster than their Internet connection will support.

Suggest stations which might have “similar” programming to the stations they are listening to or that they might enjoy.

Encompass all available broadcast technologies-WMA, MP3, Real Audio, QuickTime, and any future media.

Remember a user's preferences, favorites, and history.

This document describes the portal's functional specification, including a description of its core features.

Web site

The website of the invention is accessed with a standard Web browser by entering a URL, e.g., www.Soniclsland.com or www.Soniclsle.com. In the following description and for the purposes of discussion, reference will be made to Soniclsland.com as an exemplary web site. It is understood that any other web site or corresponding URL may be used. In one embodiment, the website of the invention will be divided into different functional areas which can be selected via a “tabbed”

interface. The tabs are:

MapTab

Yellow Pages Tab

World Tab

Search Tab

Preferences Tab

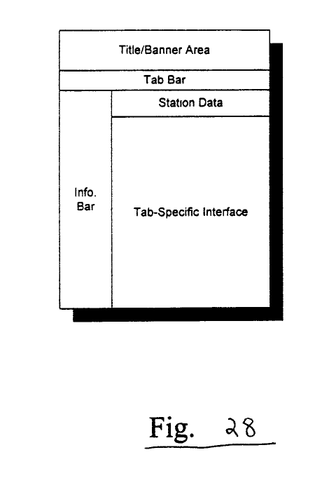

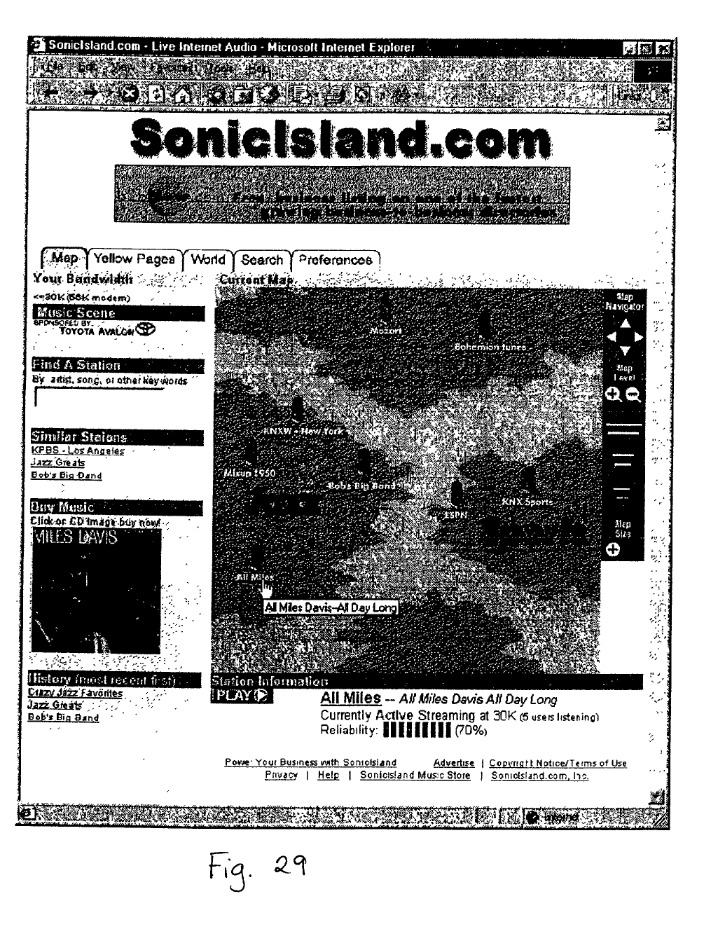

The first four tabs represent different “views” into the world of Internet Radio Stations. These tabs will have common interfaces on the left hand side (the Information Bar) and the top (the Station Data). The layout can be see graphically in FIG. 28. In addition, one example of the graphical user interface of FIG. 28 is shown in FIG. 29.

Map Tab

The Map Tab shows available stations using a unique graphical “map.” This map will feature a mythical group of islands, continents, and seas, each with a set of radio towers representing available broadcasters.

Each region on the map will be labeled to represent a different genre, with broadcasters' radio towers located within the appropriate genre. Subsets of a genre will be represented by logical sub-regions. For example, one massive island will be called “Talk Land,” and represent talk radio stations. One portion of the island will be dedicated to sports talk, another will focus on Christian talk, and so on.

The map will be displayed with rolling hills, water, forests, deserts, and other terrain. Stations will be displayed as icons. The display will be dynamic and will reflect what is happening at the moment. The stations icons' appearance will change based on advertised bandwidth, whether the stations are currently broadcasting, whether they are fall, whether they are marked as “favorites”, and other criteria. The user can zoom-in and zoom-out, scroll to other portions of the map, click on a station icon to find out more information about the station, and other functions. The display will be “live” in that information displayed for the station will change dynamically as the station's status changes. For example, if a station becomes “full”, the icon will change immediately to reflect the new status.

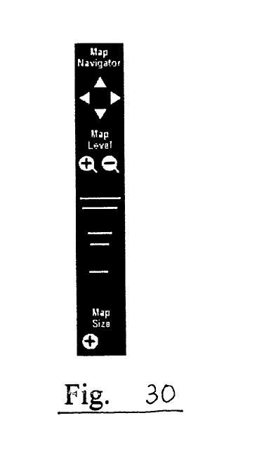

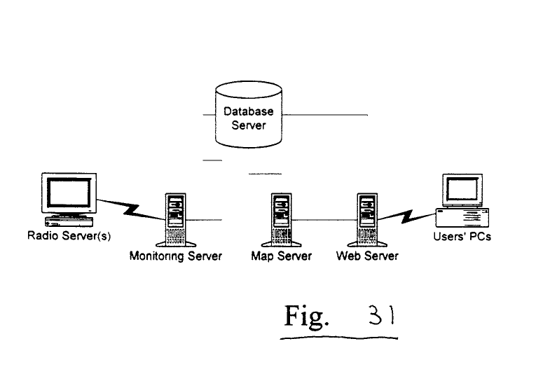

The navigation interface for the map will be a Navigation Bar (see FIG. 30) attached to the right-hand side of the map. It consists of arrows to allow the users to scroll the map in any direction, zoom controls to change the level of magnification (3 or 4 levels), and map size controls (for the user to change the size of the displayed map).

At minimum magnification, the whole virtual world will be displayed with only the high-level genres and only a few stations visible. As the user zooms in, more sub-genres will appear with more stations visible.

When the user clicks on a station icon, the icon will be highlighted and the station's information will be displayed in the Station Data.

Yellow Pages Tab

The Yellow Pages tab will display the radio stations in a hierarchical format organized by genre. Like Yahoo!'s interface, the user will be able to “drill down” to the genres in which they are interested. Each station's listing will contain the name of station, URL, bandwidth, currently playing song broadcast technology, and station reliability. Each station will also have a “Map” button which, when clicked, will immediately display the Map Tab with the selected station displayed in the center of the map. Selecting a station will display the station's information in the Station Data.

World Tab

The World Tab will only display real world radio stations (FM and AM stations). Instead of the virtual world displayed in the Map Tab, this will be an actual map of the world. In one embodiment, when a user first enters the World Tab, Soniclsland.com will display the United States, since the majority of users will be from and want to listen to U.S. stations. In the future, the user's IP address might be used to determine the default region displayed. Using the same navigation bar displayed on the Map Tab, the user can zoom into the state they are interested to locate a real station.

When the user clicks on a station icon, the icon will be highlighted and the station's information will be displayed in the Station Data.

Search Tab

The Search Tab displays a standard search engine-like interface. At the top is the search box. The user types desired search criteria and Soniclsland.com will automatically search by Artist, Station Name, Genre, and Song.

The search results will be grouped logically by:

Genre

Station Name

Artist

Song played in the last 24 hours

Song being played now

Like the Yellow Pages tab, each station entry will show live information. When a station is selected, the station's information is displayed in the Station Data.

Preferences Tab

This will be only available to registered users. This allows to change the user's filtering criteria and preferences. The user can change:

Bandwidth Filter. Only display stations broadcasting within a specified range of bit rates. There will also be selections for common internet connections (e.g. 33.6 modem, 56K modem, or “High Speed”).

Active Only Filter. Only display stations currently broadcasting.

Not Full Filter. Only display stations which haven't reached capacity.

Quality Filter. This will display stations meeting Soniclsland.com's quality heuristics.

Only Certified Stations. Limit stations shown to “real network stations”.

Preferred Media Player Filter. Since some stations broadcast using a multiplicity of media streams (e.g. Real Audio and WMA), this allows the user to select their preferred stream. They can also exclude some types of streaming media if they do not have a supported player installed on their system. For example, Linux users might want to exclude WMA.

Mailing information. Whether they want to receive the opt-in SonicIsland.com opt-in mailings.

Station Area

This is a area is positioned just below the tabs on the Map Tab, List Tab, World Tab, and Search Tab. It contains live information about the currently selected station, including:

Station Name.

URL. User may click on this to jump directly to the station's WEB site.

Bandwidth. Expressed in kbits/sec.

Currently song. This will be continuously updated.

Number of users in station. This will be continuously updated.

Popularity Ratings. These will include “x of y displayed”, and “a of b in Genre”

Broadcast technology-displayed iconically-representing RealAudio, QuickTime, WMA, or streaming MP3.

Station Reliability. This will be represented by a “signal strength” graphical bar.

Play Button. This will launch the appropriate media player for the user. Soniclsland.com may allow radio stations to use custom buttons.

Rate Button. This allows the user to “rate” the station. This will be used in combination with actual station listening patterns to judge station popularity. It will also enhance SonicIsland.com's “stickiness”, where users will tend to stay at the SonicIsland.com WEB site as long as possible.

Add Bookmark Button. This will add the bookmark for this station to the user's browser bookmark list (or “Favorites” in Internet Explorer). Selecting the bookmark will return the user to the exact station and View in Soniclsland.com, so that they can immediately click on the station to play it.

Add to Favorites Button. This adds the station to the Favorites list. If the user isn't registered, he/she will be asked to register before this feature is enable.

As discussed in the Implementation Details at the end of this document, there are different interfaces available, depending on the browser technology used by the user. Give a sufficiently recent technology browser (i.e. IE 4+or NS 4+), the Station Area will also be able to check the client to station connection in real time.

Information Bar

The Information Bar is a multifunctional area on the left side of the Map, Yellow Pages, World, and Search tabs. There will be several panes:

Quick Filters. This allows the user to quickly filter the stations without having to switch to the Preferences Tab.

Similar Stations. This will display other stations which are “similar” to the currently selected station. Similar stations are rated based on other SonicIsland.com users behaviors.

Search. Allows the user to search for stations by Artist, Station Name, Genre, and Song. Entering information into this box will immediately switch to the Search Tab.

CD Image. This box will contain an image of a CD, showing the currently playing music on the currently selected station. Clicking on the image will transfer the user over the CD purchase web site. Most likely this will be a strategic retail partner.

History. This will list the last 10 stations that the user has listened to. Clicking on a station in the history will show it immediately in the current view. Clicking on the play button will play. Including “forward” and “back” buttons to navigate throughout the history.

Favorites. This will be a listing of user's favorites. Clicking on the station name will show it immediately in the map. Clicking on the play button will play.

Additional Features

User Registration

Users will be encouraged to register with SonicIsland.com, registering will allow them to use some of the more advanced Soniclsland.com features. This will allow Soniclsland.com to track usage by user name. There will be some optional demographic information which the user will be asked to enter when they register, including age, sex, and income. There will also be a checkbox asking them if they want to “opt-in” to Soniclsland.com mailings. When users re-enter Soniclsland.com they will not be required to reenter their user name, their cookie will be used to look up this information in the database.

Certain features of Soniclsland.com will only be available to registered users. This includes Favorites, weekly mailings, automatic entry into contests, etc.

State Saving

Soniclsland.com will remember the user's current Tab, map location, zoom level, history, preferences, etc. It will automatically restore the state when the user returns to Soniclsland.com. This will be managed via cookies. If the user's browser does not accept cookies, then the state information will be saved via the user ID.

Alternate Entry Points

In addition to the standard www.Soniclsland.com entry point, there are a number of alternate entry points which can be used (and the user can bookmark). These include:

Map.SonicIsland.com-display the Map Tab.

Search.SonicIsland.com-display the Search Tab.

World.SonicIsland.com-display the World Tab.

Yp.SonicIsland.com-display the Yellow Pages Tab.

Other TBD entry points that will automatically display maps at pre-defined locations, with stations pre-selected. Broadcasters can add this type of link to their WEB site.

Favorites

When users find a station that they like, they can automatically memorize the station by clicking “Save Favorite”. This will add to their list of favorite stations. Users will be required to register to use this feature.

History

When a user listens to a station, the station will be added to the user's History. The last 10 stations will be displayed in the Information Bar.

Advertising

The Portal will also have appropriate areas for advertising. At a minimum, a space for a standard sized (468×80 pixel) banner will appear across the top. SonicIsland.com will also make available “in map” ad space.

Station Interface

Stations administrators will have their own entry point into the Soniclsland.com. Registered radio stations will be able to change their title, URL, chat, genre, map location, etc. The interface will support manual and automatic updates of this information.

Suggest Station Interface

Users can suggest stations to Soniclsland.com through this interface and register as a preferred station.

Instant Messaging Integration

Soniclsland.com will feature Instant message notification. Using standard instant messaging protocols used by AIM, ICQ, iCAST, or others, users will be notified when certain stations become available, songs are played, etc.

Data Mining Interface

Subscribers to Soniclsland.com's data mining service will be able to remotely query the database and retrieve up-to-the-minute station, song, and artist information. This would likely be implemented through an XML interface.

Implementation Details of one embodiment

Server Architecture

SonicIsland.com will be driven by a set of servers co-located at the appropriate site or sites. In one embodiment, an n-tiered server architecture may be used. The application will be split into three layers. These layers are:

1) Presentation layer

2) Application logic

3) Data

One embodiment of the architecture is shown in FIG. 26. An alternate embodiment of the architecture is shown in FIG. 31.

All servers at SonicIsland.com will be running on an industry standard platform (Intel or Sparc-based) with the Linux or Windows NT operating system. Each server module will run on one or more physical computers. The server modules and their functions are listed below:

Web Server (Presentation Layer)

This will be an industry standard WEB server (likely Apache) which will handle the user interface. The front-end will be coded using industry-standard technologies such as HTML, Java, and ActiveX. It will have a direct connection to the Internet.

The Web server will handle both the end-user interface and the station interface.

Map Server (Application Logic)

This server will dynamically generate maps requested by users. Given a location in either Soniclsland.com's virtual world (Map Tab) or the world map (World Tab), it will generate a graphical map to be displayed by the Web Server. As described later in this document, there will be several different formats which the Map Server will render the data.

Monitoring Server (Application Layer)

This server will send requests to all known stations at predefined intervals to determine their status, including currently playing song, number of available listener slots, etc. Whenever a station's status changes (including current song, number of users, etc.), the Monitoring server will update the station's entry in the Database Server. It will have a direct connection to the Internet. This will be a custom application.

Database Server (Data)

This will be an industry standard database such as Oracle, DB2, or SQL server, which will be scalable as Soniclsland.com's requirements increase. The database will store all Soniclsland.com's data.

The data stored by the database will include the following table(s):

Station tables. This includes all relevant station information, including Name, URL, Map location, physical location (if applicable), WEB address, current song, uptime history, current status, network affiliation.

Song, Artist, and Album tables. This will contain all known songs, albums, and artists, and music purchase information (the appropriate URL to launch if a user wants to purchase this CD).

User table. This will contain all Soniclsland.com users (whether registered or not) and include their cookie, user id, e-mail address, preferences, etc.

User Favorites table. This will store the user's favorites.

User History table. This will map Users to Stations and will store all stations that users have listened.

Station Song History Table. This will maintain a historical record of what each station has played over the past x weeks.

The actual tables, indices, predefined queries, and other parameters of the database will be defined at implementation time.

Data mining (queries) can deliver interesting information from the database, including:

Given Station X, what other stations do users like to hear?

What are the most popular stations in a given genre?

What stations play artist X most often (ranked by popularity)?

What are the most reliable stations?

What stations are most often shown in user's favorites.

Map Interface

The map interface is a unique display paradigm used in the Map and World Tabs. The design goal is to allow the user quick navigation to stations by balancing display space with the large number of possible stations. Because different users use different technologies to connect to the WEB-different browsers, different levels of security, different connection speeds, etc.—there really isn't a “one interface suits all” approach. Therefore, SonicIsland.com's map interface will be a hierarchy of technologies, which will be enabled based on the capabilities and desire of the end user. The interface will automatically detect the user's browser capabilities and “gracefully degrade” to give the user the best possible experience.

Basic Interface (aka Least Common Denominator Interface). For users who don't like, don't want to use, or whose browsers are incompatible with Java. The map will not be live and information displayed will only be updated when the user clicks “Refresh”. This will be implemented using a combination of standard HTML and basic graphics (GIF & JPEG). Navigating throughout the Map will reload the appropriate GIF file from the Web Server.

Advanced Interface. This interface will use advanced technologies such as Java, DHTML, and Active X to create a “live” interface with station statistics changing on the user's screen in real-time and live icons on the map. This will be limited to NS 4+and IE 4+browsers (which are approximately 80% of all installed browsers).

ActiveX Interface. Users who want the best Soniclsland.com experience can download the ActiveX interface. Since ActiveX components run locally and natively on a user's PC, they can be extremely fast. The ActiveX interface will give the user very rapid map navigation. When the user clicks on the Navigation Bar to scroll, instead of waiting for the new map to download from Soniclsland.com, the map information will display immediately, because the component will cache map data on the user's PC and only download station state information. It can also have tighter integration with Media players. ActiveX controls are only be compatible with Win32 PCs running IE 4+, however these users constitute over 60% of the browser market. We will eventually develop a Netscape-based plug-in as well.

Both the Advanced Interface and ActiveX interface will be able to test server connections directly from the user's PC. This connection status information can be sent to Soniclsland.com (with the user's permission) to give Soniclsland.com valuable station reliability data.

The ActiveX-based interface will also be the basis for Soniclsland.com's stand-alone (Win32) application. This would be implemented as a simple Win32 wrapper around the ActiveX control.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A system for displaying a number of interactive navigation interfaces, each including a number of graphical symbols representing data sources, said system comprising:
a first presentation device having a display element;
a central server configured to process generic map data representing an interactive graphical navigation interface, said generic map data being formatted in accordance with a first protocol; and
a first presentation layer in communication with said central server, said first presentation layer being configured to convert said generic map data into displayable map data formatted in accordance with a second protocol compatible with said first presentation device.

2. A system according to claim 1, further comprising a map database in communication with said central server, said map database containing generic map data formatted in accordance with said first protocol.

3. A system according to claim 2, wherein said map database further contains data related to end user preferences.

4. A system according to claim 2, wherein said map database further contains data related to system administrator preferences.

5. A system according to claim 1, further comprising an applicationspecific database in communication with said central server, said application-specific database containing information related to content available to said first presentation device.

6. A system according to claim 5, wherein said application-specific database contains information related to at least one of the following: television program listings, radio program listings, streaming media files, software applications, uniform resource locators, and service provider features.

7. A system according to claim 1, wherein said first presentation layer is configured for compatibility with at least one of the following: a television broadcasting system, a wireless telephone system, a personal digital assistant system, and a web browser system.

8. A system according to claim 1, wherein said first presentation layer comprises:
an application server configured to receive said generic map data from said central server; and
a communication link for establishing communication with said first presentation device, said communication link conveying said displayable map data to said first presentation device.

9. A system according to claim 8, wherein said communication link comprises at least one of the following: a broadband cable connection, a satellite link, a wireless application protocol (WAP) link, a wireless personal digital assistant (PDA) protocol link, and a TCP/IP link.

10. A system according to claim 1, further comprising a communication link between said central server and said first presentation layer, said communication link conveying said generic map data to said first presentation layer.

11. A system according to claim 10, wherein said communication link conveys said generic map data via the TCP/IP suite of data transmission protocols.

12. A system according to claim 1, further comprising:
a second presentation device having a display element; and
a second presentation layer in communication with said central server, said second presentation layer being configured to convert said generic map data into displayable map data formatted in accordance with a third protocol compatible with said second presentation device.

13. A system according to claim 1, further comprising a producer tool application configured to communicate with said central server.

14. A method for displaying a number of active symbols representing data sources at a presentation device, said method comprising:
receiving a map request at a central server, said central server being configured to process map data representing interactive graphical navigation interfaces;
retrieving generic map data identified by said map request, said generic map data being formatted in accordance with a first protocol; and
converting said generic map data into displayable map data formatted in accordance with a second protocol compatible with a presentation device having a display element.

15. A method according to claim 14, wherein said retrieving step retrieves said generic map data from a map database in communication with said central server.

16. A method according to claim 14, wherein:
said converting step is performed by an application server configured to receive said generic map data from said central server; and
said method further comprises the step of transmitting said generic map data from said central server to said application server.

17. A method according to claim 16, wherein said transmitting step transmits said generic map data over a communication link using the TCP/IP suite of data transmission protocols.

18. A method according to claim 14, further comprising the step of rendering said displayable map data on said display element.

19. A method according to claim 14, further comprising the steps of:
receiving, at said presentation layer, a control signal generated in response to the identification of an active symbol at said presentation device; and
conveying, to said presentation device, information related to content represented by said active symbol, said conveying step being responsive to said control signal.

20. A method according to claim 19, wherein said conveying step conveys information related to at least one of the following: current television program listings, current radio program listings, quality of service parameters, availability of content from said data source, and status of said presentation device.

21. A method according to claim 14, further comprising the steps of:
receiving, at said presentation layer, a control signal generated in response to a request for content corresponding to an active symbol selected at said presentation device; and providing content to a user of said presentation device in response to said control signal.

22. A method according to claim 21, wherein said providing step provides said content to said presentation device.

23. A system for displaying a number of interactive navigation interfaces, each including a number of graphical symbols representing data sources, said system comprising:
a presentation device having a display element;
a central server configured to process generic map data representing an interactive graphical navigation interface, said central server being further configured to receive information related to content available to said presentation device;
a presentation layer in communication with said central server, said presentation layer being configured to generate, in response to said generic map data, a displayable symbol having at least one variable characteristic associated therewith, where said displayable symbol represents a data source; wherein
said presentation layer is configured to alter said at least one variable characteristic of said displayable symbol in response to said information.

24. A system according to claim 23, wherein said information represents current operating conditions related to said data source.

25. A system according to claim 23, wherein said information relates to at least one of the following: current television program listings, current radio program listings, quality of service parameters, availability of content from said data source, and status of said presentation device.

26. A system according to claim 23, further comprising an application-specific database in communication with said central server, said application-specific database containing said information.

27. A system for displaying a number of interactive navigation interfaces, each including a number of graphical symbols representing data sources, said system comprising:
a central server configured to process generic map data representing an interactive graphical navigation interface, said generic map data being formatted in accordance with a first protocol; and
a plurality of presentation layers in communication with said central server, each of said plurality of presentation layers being configured to convert said generic map data into displayable map data formatted in accordance with a second protocol.

28. A system according to claim 27, wherein said plurality of presentation layers comprises:
a first presentation layer in communication with said central server, said first presentation layer being configured to convert said generic map data into displayable map data formatted for compatibility with a first presentation device; and
a second presentation layer in communication with said central server, said second presentation layer being configured to convert said generic map data into displayable map data formatted for compatibility with a second presentation device.

29. A system according to claim 27, wherein each of said plurality of presentation layers supports a different type of presentation device.

30. A system according to claim 27, wherein said plurality of presentation layers support at least two of: a personal computer presentation device, a personal digital assistant presentation device, a wireless telephone presentation device, and a television set-top presentation device.
